(19) United States
(12) Patent Application Publication
(10) Pub. No.: US 2020/0180617 A1
(43) Pub. Date: Jun. 11, 2020

(54) VEHICLE CONTROL DEVICE

(71) Applicant: TOYOTA JIDOSHA KABUSHIKI KAISHA, Toyota-shi (JP)

(72) Inventors: Yuki TEZUKA, Miyoshi-shi (JP); Takashi Maeda, Nagoya-shi (JP); Tsunekazu Yasoshima, Nagoya-shi (JP); Soichi Okubo, Okazaki-shi (JP)

(73) Assignee: TOYOTA JIDOSHA KABUSHIKI KAISHA, Toyota-shi (JP)

(21) Appl. No.: 16/565,692

(22) Filed: Sep. 10, 2019

(30) Foreign Application Priority Data
Dec. 7, 2018 (JP) 2018-230132

(51) Int. Cl. B60W 30/12

(52) U.S. Cl. CPC B60W 30/12; B60W 2720/125; B60W 2720/106; B60W 2550/22

(57) ABSTRACT

A vehicle control device executes a speed management control to let the vehicle travel in such a manner that a vehicle speed of when the vehicle is traveling in a curve section does not exceed a target vehicle speed. The vehicle control device executes a lane tracing control to let the vehicle travel in such a manner that the vehicle travels along a traveling lane, in a time period from a start time point to an end time point. The vehicle control device sets the target vehicle speed to a first target vehicle speed in a first situation in which the lane tracing control is not being executed, and sets the target vehicle speed to a second target vehicle speed which is lower than the first target vehicle speed in a second situation in which the lane tracing control is being executed.

### BACKGROUND

### Technical Field

The present disclosure relates to a vehicle control device configured to control a vehicle (running state of the vehicle) in such a manner that a vehicle speed does not exceed a target vehicle speed when the vehicle travels/runs in a curve section.

### Related Art

Hitherto, there has been known a vehicle control device (hereinafter, referred to as “a conventional device”) configured to be able to execute both of a lane tracing control (an automatic steering control) and a speed management control (a vehicle speed control). For example, such a conventional device is disclosed in Japanese Patent Application Laid-open No. 2017-114195. The lane tracing control is a control for automatically controlling a steering angle of a steered wheel of a vehicle without a driver's steering operation so that the vehicle can travel along a lane in which the vehicle is traveling. The speed management control is a control for controlling the vehicle in such a manner that a vehicle speed does not exceed a target vehicle speed which is an upper limit vehicle speed when the vehicle is traveling in the curve section.

The speed management control is executed when the vehicle travels in the curve section or sections in the vicinity of an entrance of and/or an exit of the curve section. The lane tracing control is executed when a predetermined condition is satisfied regardless of whether or not the vehicle travels in the curve section.

Accordingly, the speed management control can be executed in either one of a first situation in which the lane tracing control is not being executed and a second situation in which the lane tracing control is being executed.

### SUMMARY

The driver is operating a steering wheel in the first situation. In other words, the driver is performing a steering operation in the first situation. In contrast, the driver does not perform the steering operation substantially in the second situation.

However, the speed management control which the conventional device executes in the first situation is the same as the speed management control which the conventional device executes in the second situation. A possibility that the driver feels uneasy about whether or not the vehicle can travel stably in the curve section (whether or not the vehicle can negotiate the curve section) may sometimes be high in the second situation, because the driver does not operate the steering wheel in the second situation.

The present disclosure has been made to solve the problem described above. The present disclosure has an object to provide a vehicle control device for being able to lower a possibility that the driver feels uneasy when the speed management control is executed in the second situation in which the lane tracing control is being executed.

A vehicle control device (hereinafter, may be referred to “the present disclosure device”) according to the present disclosure comprises:

sensing devices (11, 12) configured to acquire information on at least a traveling state of a vehicle;

actuators (26, 34, 43) configured to control the traveling state of the vehicle; and

a control unit (10) configured to:

execute a speed management control (Steps 600 to 695) to let the vehicle travel using the information and the actuators in such a manner that a vehicle speed (Vs) of when the vehicle is traveling in a curve section does not exceed a target vehicle speed serving as an upper limit speed; and

execute a lane tracing control (Steps 500 to 595) to let the vehicle travel using the information and the actuators in such a manner that the vehicle travels along a lane in which the vehicle is traveling, in a time period from a start time point at which a predetermined start condition becomes satisfied (“Yes” at Step 515) to an end time point at which a predetermined end condition becomes satisfied (“Yes” at Step 530).

The control unit is configured to:

set the target vehicle speed to a first target vehicle speed (a block BL2 shown in FIG. 7, Step 710, Step 715) in a first situation in which the lane tracing control is not being executed (“Yes” at Step 640); and

set the target vehicle speed to a second target vehicle speed which is lower than the first target vehicle speed (a block shown in FIG. 8, Step 805, Step 715 shown in FIG. 8) in a second situation in which the lane tracing control is being executed (“No” at Step 640).

According to the above present disclosure device, a maximum value of the vehicle speed of when the vehicle travels in the curve section in the second situation in which the lane tracing control is being executed is made smaller than a maximum value of the vehicle speed of when the vehicle travels in the curve section in the first situation in which the lane tracing control is not being executed. Therefore, a possibility that the driver feels uneasy about whether or not the vehicle can travel stably in the curve section in the second situation (whether or not the vehicle can negotiate the curve section) can be lowered.

In one embodiment of the present disclosure,

the control unit is configured to:

determine/obtain (Step 710), as a first upper limit lateral acceleration, an allowable upper limit value of an acceleration acting on the vehicle in a vehicle width direction of the vehicle in a period when the vehicle travels in the curve section in the first situation, and determine/obtain (Step 715) the first target vehicle speed based on the first upper limit lateral acceleration; and

determine/obtain (Step 805), as a second upper limit lateral acceleration, an allowable upper limit value of an acceleration acting on the vehicle in the vehicle width direction of the vehicle in a period when the vehicle travels in the curve section in the second situation so as to make the second upper limit lateral acceleration be smaller than first upper limit lateral acceleration, and determine/obtain (Step 715 shown in FIG. 8) the second target vehicle speed based on the second upper limit lateral acceleration.

According to the thus configured embodiment, a maximum value of the gravitational acceleration (lateral G) which acts on the vehicle in the vehicle width direction of when the vehicle travels in the curve section in the second situation is smaller than a maximum value of the lateral G which acts on the vehicle of when the vehicle travels in the curve section in the first situation. Accordingly, a possibility that the driver feels uneasy when the vehicle travels in the curve section in the second situation can be lowered.

In one embodiment of the present disclosure,

the control unit is configured to:

decrease the vehicle speed to the first target vehicle speed in such a manner that a magnitude of an acceleration of the vehicle does not exceed a first threshold acceleration, in the first situation (Step 735, Step 740, Step 755); and decrease the vehicle speed to the second target vehicle speed in such a manner that the magnitude of the acceleration of the vehicle does not exceed a second threshold acceleration (a block BL7 shown in FIG. 8) which is set to be smaller than the first threshold acceleration, in the second situation (Step 810, Step 740 shown in FIG. 8, Step 755 shown in FIG. 8).

According to the thus configured embodiment, the magnitude of the acceleration of when the vehicle travels in the curve section in the second situation is made smaller than the magnitude of the acceleration of when the vehicle travels in the curve section in the first situation. Therefore, the vehicle can be decelerated more gently/slowly when the vehicle travels in the curve section in the second situation, as compared with a case where the vehicle travels in the curve section in the first situation. Consequently, the possibility that the driver feels uneasy when the vehicle travels in the curve section in the second situation can be lowered.

In one embodiment of the present disclosure,

the control unit is configured to:

decrease the vehicle speed to the first target vehicle speed in such a manner that a magnitude of a derivation value of an acceleration of the vehicle does not exceed a first threshold jerk, in the first situation (Step 745, Step 750, Step 760); and

decrease the vehicle speed to the second target vehicle speed in such a manner such that the magnitude of the derivation value of the acceleration of the vehicle does not exceed a second threshold jerk (a block BL8 shown in FIG. 8) which is set to be smaller than the first threshold jerk, in the second situation (Step 815, Step 750 shown in FIG. 8, Step 760 shown in FIG. 8).

According to the thus configured embodiment, the magnitude of the derivation value of the acceleration (i.e., jerk) of when the vehicle travels in the curve section in the second situation is made smaller than the magnitude of the derivation value of the acceleration of when the vehicle travels in the curve section in the first situation. Therefore, a magnitude of a change amount (time variation) in the deceleration of when the vehicle travels in the curve section in the second situation is made smaller, as compared with a case where the vehicle travels in the curve section in the first situation. Consequently, the possibility that driver feels uneasy when the vehicle travels in the curve section in the second situation can be lowered.

In one embodiment of the present disclosure,

the control unit is configured to:

start decreasing the vehicle speed to the first target vehicle speed at a first start timing in the first situation (“Yes” at Step 930, Step 935, “Yes” at Step 940); and

start decreasing the vehicle speed to the second target vehicle speed at a second start timing in the second situation, the second timing being determined to come earlier than the first start timing (“No” at Step 930, Step 955, “Yes” at Step 940).

According to the thus configured embodiment, a timing at which the control device starts decreasing the vehicle speed in the second situation can come earlier than (prior to) a timing at which the control device starts decreasing the vehicle speed in the first situation. Therefore, a period of time for decelerating in the second situation is made longer than a period of time for decelerating in the first situation. As a result, the vehicle can be decelerated more gently/slowly in the second situation than in the first situation. Accordingly, a possibility that the vehicle speed is decreased to the target vehicle speed in a short time can be lowered, so that a possibility that the driver feels uneasy due to the sudden and/or great deceleration of the vehicle can be lowered.

In one embodiment of the present disclosure,

the control unit is configured to:

determine whether or not a driver of the vehicle has performed a predetermined operation (17, Step 1210); and

set the second target vehicle speed to a value smaller than a value to which the second target vehicle speed is set when the driver has not performed the predetermined operation (Step 1230, a second customization lateral G(R)′ map shown in FIG. 11), when the driver has performed the predetermined operation (“No” at Step 1210).

When the driver wants the vehicle to travel in the curve section at a lower speed in the second situation, the driver just performs the predetermined operation. In other words, the driver can set/adjust “the maximum value of the vehicle speed of when the vehicle travels in the curve section in the second situation” in accordance with the driver's preference (by simply performing the predetermined operation).

In one embodiment of the present disclosure,

the sensing devices include at least a device configured to acquire information on surroundings of the vehicle; and

the control unit is configured to set the second target vehicle speed to a value smaller than a value to which the second target vehicle speed is set when the information on the surroundings does not satisfy a predetermined condition (Step 1315, Step 1325, Step 1335, Step 1345, Step 715), when the information on the surroundings satisfies the predetermined condition (“Yes” at Step 1310, “Yes” at Step 1320, “Yes” at Step 1330, “Yes” at Step 1340).

According to the thus configured embodiment, “a possibility that the vehicle travels in the curve section at a low speed” is heightened when the information on the surroundings around the vehicle satisfies the predetermined condition (specific condition), as compared with a case where the information does not satisfy the predetermined condition. For example, the predetermined condition may be a condition to be satisfied when the surroundings has become likely to cause the driver to feel uneasy (i.e., a condition to be satisfied when the information on the surroundings indicates that the surroundings are as such that cause the driver to easily feel uneasy). Accordingly, the thus configured embodiment can lower the possibility that the driver feels uneasy when the vehicle travels in the curve section in the surroundings which are likely to cause the driver to feel uneasy.

In one embodiment of the present disclosure,

the control unit is configured to determine that the information on the surroundings satisfies the predetermined condition when at least one of a first condition, a second condition, a third condition, and a fourth condition is satisfied.

The first condition is satisfied when a width of the lane is equal to or smaller than a threshold width (Step 1310).

The second condition is satisfied when a distance between the vehicle and an other vehicle in a vehicle width direction of the vehicle is equal to or shorter than a first threshold distance (Step 1320).

The third condition is satisfied when the other vehicle approaches the vehicle in the vehicle width direction at a speed which is equal to or higher than a threshold speed (Step 1330).

The fourth condition is satisfied when a distance between the vehicle and a structure around the vehicle is equal to or shorter than a second threshold distance (Step 1340).

According to the thus configured embodiment, the control unit can determine whether or not the surroundings is the surroundings which is likely to cause the driver to feel uneasy, more accurately/properly.

In the above description, in order to facilitate the understanding of the disclosure, reference symbols used in embodiment of the present disclosure are enclosed in parentheses and are assigned to each of the constituent features of the disclosure corresponding to the embodiment. However, each of the constituent features of the disclosure is not limited to the embodiment as defined by the reference symbols. Other objects, other features, and accompanying advantages of the present disclosure can be readily understood from a description of the embodiments of the present disclosure provided referring to the accompanying drawings.

### BRIEF DESCRIPTION OF THE DRAWINGS

FIG. 1 is a schematic system configuration diagram of a vehicle control device (the present control device) according to an embodiment.

FIG. 2 is a diagram for illustrating a lane tracing control.

FIG. 3 is a diagram illustrating an operation of the present control device when a vehicle travels in a curve section.

FIG. 4 is a flowchart illustrating a routine executed by a CPU of a driving support ECU (DSECU) illustrated in FIG. 1.

FIG. 5 is a flowchart illustrating the other routine executed by the CPU of the DSECU illustrated in FIG. 1.

FIG. 6 is a flowchart illustrating the other routine executed by the CPU of the DSECU illustrated in FIG. 1.

FIG. 7 is a flowchart illustrating a routine which the CPU executes when proceeding to a first speed management control in the routine illustrated in FIG. 6.

FIG. 8 is a flowchart illustrating a routine which the CPU executes when proceeding to a second speed management control in the routine illustrated in FIG. 6.

FIG. 9 is a flowchart illustrating a part of a routine which the CPU of the present control device according to a first modification example executes.

FIG. 10 is a flowchart illustrating a part of a routine which the CPU of the present control device according to the first modification example executes.

FIG. 11 is a diagram for illustrating a Map lateral G(R) of the present control device according to a second modification example executes.

FIG. 12 is a flowchart illustrating a routine which the CPU of the present control device according to the second modification example executes.

FIG. 13 is a flowchart illustrating a routine which the CPU of the present control device according to a third modification example executes.

### DETAIL DESCRIPTION

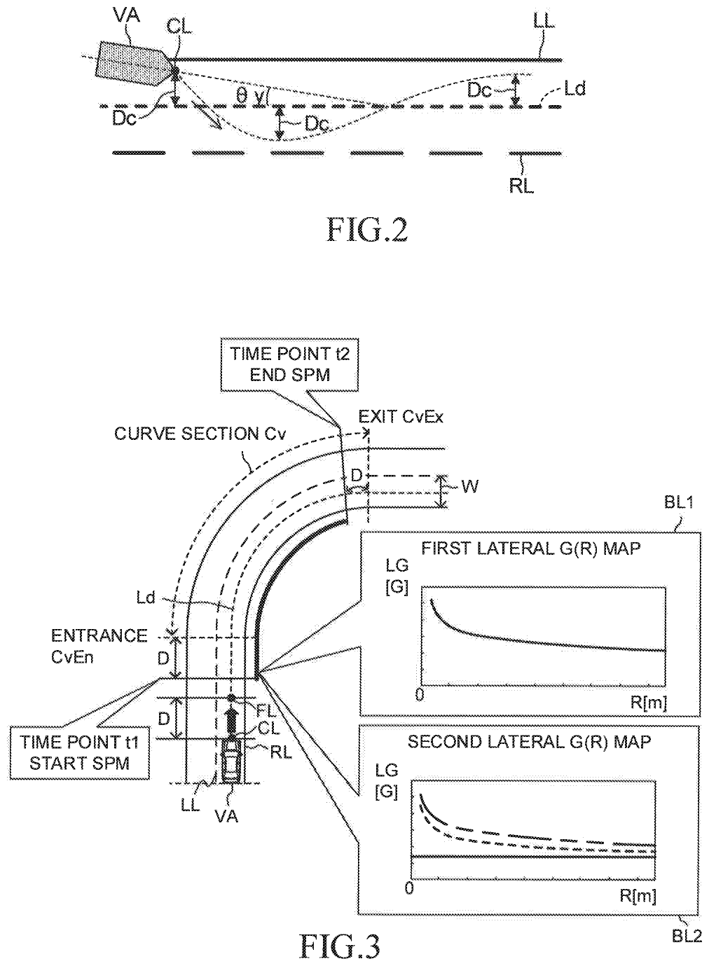

A vehicle control device (hereinafter, referred to as “the present control device”) according to an embodiment of the present disclosure is installed in a vehicle VA (referring to FIG. 2).

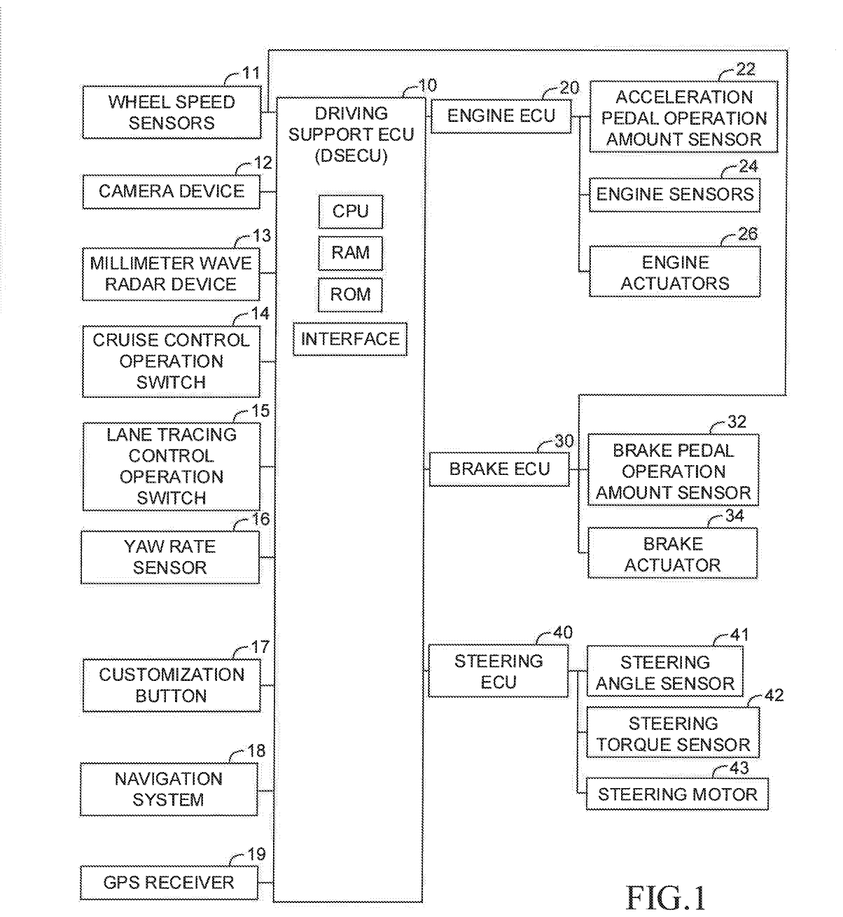

As shown in FIG. 1, the present control device comprises a driving support ECU (hereinafter, referred to as “a DSECU”) 10, an engine ECU 20, a brake ECU 30, and a steering ECU 40. The above ECUs are connected to each other via a controller area network (CAN) (not shown) to be able to mutually transmit and receive information to/from those ECUs.

The ECU is an abbreviation of an “Electronic Control Unit”. The ECU is an electronic control circuit which includes, as a main component, a microcomputer having a CPU, a ROM, a RAM, an interface, and the like. The CPU achieves various functions through executing instructions (routines) stored in the ROM. Some or all of those ECUs may be integrated into a single ECU.

The present control device comprises a plurality of wheel speed sensors 11, a camera device 12, a millimeter wave radar device 13, a cruise control operation switch 14, a lane tracing control operation switch 15, a yaw rate sensor 16, a customization button 17, a navigation system 18, and a GPS receiver 19. Those are connected to the DSECU 10. The customization button 17, the navigation system 18, and the GPS receiver 19 will be described later in detail when it comes to modification examples.

The wheel speed sensors 11 are provided for wheels of the vehicle VA, respectively. Each of the wheel speed sensors 11 generates one pulse signal (a wheel pulse signal), when the corresponding wheel rotates by a predetermined angle. The DSECU 10 counts the number of the pulse signals transmitted by each of the wheel speed sensors 11 for/within a predetermined time, and calculates a rotation speed (a wheel speed) of the corresponding wheel based on the counted number of the pulse signals. The DSECU 10 calculates a vehicle speed Vs indicative of a speed of the vehicle VA based on the rotation speeds of the wheels. For example, the DSECU 10 calculates the average of the rotation speeds of the four wheels as the vehicle speed Vs.

The camera device 12 is provided at the upper part of an windshield in a cabin of the vehicle VA. The camera device 12 obtains image data of an image (a camera image) of a front area ahead of the vehicle VA. The camera device 12 obtains, from the obtained image data, object information on an object(s), white line information on a white line(s) (line marker(s)) which define a lane in which the vehicle travels, and the like. The object information includes a distance to an obstacle, a direction of the obstacle, and the like.

The millimeter wave radar device 13 has an unillustrated millimeter wave transmission and reception unit and an unillustrated processing unit. The millimeter wave radar device 13 is provided at a position which is a front end of the vehicle VA and a center in a vehicle width direction of the vehicle VA. The millimeter wave transmission and reception unit transmits a millimeter wave which propagates/spreads in an area with a predetermined angle in a right direction and a left direction from a center axis extending in a forward direction of the vehicle VA. The object (e.g. an other vehicle, a pedestrian, a two-wheeled vehicle (a motorcycle, or a bicycle), or the like) reflects the transmitted millimeter wave. The millimeter transmission and reception unit receives the reflected wave.

The processing unit of the millimeter wave radar device 13 obtains the object information based on the reflected wave which is received. The object information includes a distance to the object, a relative speed Vfx(n) of the object in relation to the vehicle VA, a direction of the object in relation to the vehicle VA, and the like. If the object is the other vehicle, the distance to the other vehicle may be referred to as “an inter-vehicle distance Dfx(n)”. The direction of the object in relation to the vehicle VA is indicated by an angle between “a straight line passing through a position of the object and a position of the millimeter wave transmission and reception unit of the millimeter wave radar device 14” and “the above described center line”.

More specifically, the processing unit obtains the object information based on a time period from a time point at which the millimeter wave is transmitted to a time point at which the reflected wave of the millimeter wave is received, an attenuation level of the reflected wave, a phase difference between the transmitted millimeter wave and the received reflected wave, and the like.

The DSECU 10 obtains final object information which is used by a cruise control described later, by modifying the object information obtained by the millimeter wave radar device 13 based on the object information obtained by the camera device 12.

The cruise control operation switch 14 includes a button(s) which a driver of the vehicle operates when the driver wants to start or end the cruise control. The cruise control operation switch 14 transmits, to the DSECU 10, a cruise control start signal indicating that the driver is requesting the DSECU 10 to start the cruise control (the cruise control start signal indicative of a request of the driver for starting the cruise control), when the driver operates the cruise control operation switch 14 in a time period in which the cruise control is not being executed. The cruise control operation switch 14 transmits, to the DSECU 10, a cruise control end signal indicating that the driver is requesting the DSECU 10 to end the cruise control (the cruise control end signal indicative of a request of the driver for ending the cruise control), when the driver operates the cruise control operation switch 14 in a time in which the cruise control is being executed.

In addition, a setting switch (not shown) is provided in the vicinity of the cruise control operation switch 14. The driver operates the setting switch in order to change/set a target inter-vehicle time period Ttgt which is used by an adaptive cruise control (ACC) described later, and a target vehicle speed for a cruise control (constant speed running control).

The lane tracing control operation switch 15 includes a button(s) which the driver operates when the driver wants to start or end a lane tracing control (hereinafter, may be referred to as “a LTA (Lane Tracing Assist)”). The lane tracing control operation switch 15 transmits, to the DSECU 10, a lane tracing control start signal indicating that the driver is requesting the DSECU 10 to start the lane tracing control (the lane tracing control start signal indicative of a request of the driver for starting the lane tracing control), when the driver operates the lane tracing control switch 15 in a time period in which the lane tracing control is not being executed. The lane tracing control operation switch 15 transmits, to the DSECU 10, a lane tracing control end signal indicating that the driver is requesting the DSECU 10 to end the lane tracing control (the lane tracing control end signal indicative of a request of the driver for ending the lane tracing control), when the driver operates the lane tracing control operation switch 15 in a time period in which the lane tracing control is being executed.

The yaw rate sensor 16 measures a yaw rate Yr acting on the vehicle VA, and transmits a signal indicative of the measured yaw rate Yr.

The engine ECU 20 is connected to an acceleration pedal operation amount sensor 22 and engine sensors 24. The engine ECU 20 receives detection signals transmitted from those sensors.

The acceleration pedal operation amount sensor 22 measures an operation amount of an unillustrated acceleration pedal (an accelerator) of the vehicle VA. The operation amount of the acceleration pedal is referred to as “an acceleration pedal operation amount AP”. The acceleration pedal operation amount AP is “0” when the driver does not operate the acceleration pedal.

The engine sensors 24 measure various drive state amounts of “a gasoline-fuel injection, spark-ignition-type, and multi-cylinder engine (not shown) which is a driving source of the vehicle VA”. The engine sensors 24 include a throttle valve opening degree sensor, an engine rotation speed sensor, an intake air amount sensor, and the like.

Furthermore, the engine ECU 20 is connected to engine actuators 26 such as a throttle valve actuator and fuel injectors. The engine ECU 20 changes torque generated by the engine through driving the engine actuator 26 to adjust driving force applied to the vehicle VA.

The engine ECU 20 determines a target throttle valve opening degree TAtgt in such a manner that the throttle valve opening degree TAtgt becomes larger as the acceleration pedal operation amount AP becomes larger. The engine ECU 20 drives the throttle valve actuator in such a manner that an opening degree of a throttle valve coincides with the target throttle valve opening degree TAtgt.

The brake ECU 30 is connected to the wheel speed sensors 11 and a brake pedal operation amount sensor 32. The brake ECU 30 receives detection signals transmitted from those sensors.

The brake pedal operation amount sensor 32 measures an operation amount of an unillustrated brake pedal of the vehicle VA. The operation amount of the brake pedal is referred to as “a brake pedal operation amount BP”. The brake pedal operation amount BP is “0” when the driver does not operate the brake pedal.

The brake ECU 30 calculates the rotation speed of each of the wheels and the vehicle speed Vs based on the wheel pulse signals transmitted from the wheel speed sensors 11, similarly to the DSECU 10. The brake ECU 30 may obtain, from the DSECU 10, “the rotation speed of each of the wheels and the vehicle speed Vs” calculated by the DSECU 10. In this case, the brake ECU 30 needs not to be connected to the wheels sensors 11.

The brake ECU 30 is connected to a brake actuator 34 which is a hydraulic control actuator. The brake actuator 34 is provided in an unillustrated hydraulic circuit between an unillustrated master cylinder and unillustrated friction brake devices. The master cylinder pressurizes working oil by using a depressing force applied to the brake pedal. The frictional brake devices include well-known wheel cylinders. The wheel cylinders are provided in the wheels respectively. The brake actuator 34 adjusts oil pressure applied to each of the wheel cylinders to adjust brake force of the vehicle VA.

The brake ECU 30 determines a target acceleration GBPtgt that has a negative value (i.e., a target deceleration that has a positive value) based on the brake pedal operation amount BP. The brake ECU 30 drives the brake actuator 34 in such a manner that an actual acceleration of the vehicle VA coincides with the target acceleration.

The steering ECU 40 is a control device of a well-known electric power steering system. The steering ECU 40 is connected to a steering angle sensor 41, a steering torque sensor 42, and a steering motor 43. The steering motor 43 is embedded in steering mechanism (not shown) including a steering wheel (not shown), a steering shaft (not shown) connected to the steering wheel, steering gear mechanism (not shown), and the like.

The steering angle sensor 41 measures a steering angle θ of the vehicle VA.

The steering torque sensor 42 measures a steering torque TR applied to the steering shaft.

The steering motor 43 generates torque through using electric power. The direction, magnitude, and the like, of the torque are adjusted by the steering ECU 30. The torque is used to generate a steering assist torque and/or to steer a left steered wheel and a right steered wheel. Accordingly, the steering motor 43 can change the steering angle θ of the vehicle VA. It should be noted that the electric power is supplied from a vehicle battery (not shown) installed in the vehicle VA.

(Detail Description of Vehicle Control)

1. Cruise Control (ACC)

The DSECU 10 executes, as the cruise control, either one of a distance maintaining control and the constant speed running/traveling control.

1.1: ACC target acceleration for the distance maintaining control

The DSECU 10 determines/specifies an other vehicle ahead (in front) of the vehicle VA (hereinafter, referred to as an “objective-forward-vehicle (a)” or “follow-up vehicle ahead (a)”) which the vehicle VA should follows (i.e., trails), according to a well-known method. For example, such a method is disclosed in Japanese Patent Application Laid-open No. 2015-072604. The DSECU 10 calculates a target inter-vehicle distance Dtgt (=Ttgt·Vs) between the vehicle VA and the objective-forward-vehicle (a) by multiplying a target inter-vehicle time period Ttgt by the vehicle speed Vs. The driver sets the target inter-vehicle time period Ttgt to a driver's desired value by operating the setting switch. However, the target inter-vehicle time period Ttgt may be a fixed value.

The DSECU 10 calculates a distance deviation ΔD1 (=Dfx(a)−Dtgt) by subtracting the target inter-vehicle distance Dtgt from “an inter-vehicle distance Dfx(a) which is a distance between the objective-forward-vehicle (a) and the vehicle VA”. The DSECU 10 calculates an ACC target acceleration GACCtgt by applying the distance deviation ΔD1 to the following equation (1). Vfx(a) in the equation (1) indicates a relative speed of the objective-forward-vehicle (a). Each of “Kracc”, “K1acc”, and “K2acc” in the equation (1) indicates a predetermined control gain (coefficient). The “Vfx(a)” in the equation (1) is defined as a value which is a positive value and becomes larger as the inter-vehicle distance Dfx(a) becomes longer.

GACCtgt=Kracc·(K1acc·ΔD1+K2acc·Vfx(a)) (1)

1.2: ACC Target Acceleration for the Constant Speed Traveling Control

When the DSECU 10 detects no objective-forward-vehicle (a), the DSECU 10 controls an acceleration of the vehicle VA in such a manner that the vehicle speed Vs of the vehicle VA coincides with (or becomes equal to) the target vehicle speed for the constant speed traveling control. For example, the driver sets the target vehicle speed for the constant speed traveling control to a driver's desired value/speed by operating the cruise control operation switch 14. When the vehicle speed Vs is lower than the target vehicle speed, the DSECU 10 sets the ACC target acceleration GACCtgt to a positive constant value (Gtgt) or increases the ACC target acceleration GACCtgt gradually by a predetermined amount AG per a predetermined time. On the other hand, when the vehicle speed Vs is higher than the target vehicle speed, the DSECU 10 sets the ACC target acceleration GACCtgt to a negative constant value (−Gtgt) or decreases the ACC target acceleration GACCtgt gradually by the predetermined amount AG per the predetermined time.

1.3: Execution of ACC

The DSECU 10 transmits the thus calculated ACC target acceleration GACCtgt calculated to the engine ECU 20 and the brake ECU 30 as a driving support target acceleration GStgt.

The engine ECU 20 increases or decreases the target throttle valve opening degree TAtgt in such a manner that an actual acceleration in the longitudinal direction of the vehicle VA (hereinafter, simply referred to as “an actual acceleration dg”) coincides with the driving support target acceleration GStgt transmitted from the DSECU 10. Furthermore, the brake ECU 30 decelerates the vehicle VA by controlling the brake force using the brake actuator in such a manner that the actual acceleration dg of the vehicle VA coincides with the driving support target acceleration GStgt, when the actual acceleration dg is larger than the driving support target acceleration GStgt even when and after the target throttle valve opening degree TAtgt becomes “0 (the minimum value)”. It should be noted that the brake ECU 30 determines/adopts either one of a target acceleration determined depending on the brake pedal operation amount BP and the driving support target acceleration GStgt, whichever is smaller, as a final target acceleration. Thereafter, the brake ECU 30 controls the brake actuator 34 based on the determined final target acceleration. In other words, the brake ECU 30 is configured to execute a brake override.

As described above, the engine ECU 20 determines the target throttle valve opening degree TAtgt based on the acceleration pedal operation amount AP. When the target throttle valve opening degree TAtgt determined based on the acceleration pedal operation amount AP is larger than the target throttle valve opening degree TAtgt determined through the cruise control (determined based on the driving support target acceleration GStgt), the engine ECU 20 controls the actual throttle valve opening degree TA based on the target throttle valve opening degree TAtgt determined based on the acceleration pedal operation amount AP. In other words, the engine ECU 20 is configured to execute an acceleration override.

2: Lane tracing control (LTA)

The lane tracing control is a control (a steering control) for changing the steering angle by applying, to the steering mechanism, the steering torque TR which enables the vehicle VA to keep a position of the vehicle VA (a position in a lane width direction of the vehicle VA) within a range in the vicinity of a target traveling line Ld (referring to FIG. 2) in a lane in which the vehicle VA is traveling (hereinafter, referred to as “a self-lane” or “a currently-running-road”). The lane tracing control is well-known and is disclosed, for example, in Japanese Patent Application Laid-open No. 2008-195402, Japanese Patent Application Laid-open No. 2009-190464, Japanese Patent Application Laid-open No. 2010-6279, and Japanese Patent No. 4349210. Thus, the lane tracing control will next be briefly described.

As shown in FIG. 2, the DSECU 10 specifies (recognizes) “a left white line LL and a right white line RL” in the self-lane based on the image data obtained by the camera device 12, and determines a center line of a pair of the recognized white lines as the target traveling line (target traveling route) Ld. Furthermore, the DSECU 10 calculates a curvature C of the target traveling line Ld and “a position and a direction of the vehicle VA in relation to a traveling lane (the self-lane) defined by the left white line LL and the right white line RL”.

The DSECU 10 calculates a distance Dc (hereinafter, referred to as “a center distance Dc”) between a front end center position CL of the vehicle VA and the target traveling line Ld in a road width direction, and a differential angle θy (hereinafter, referred to as “a yaw angle θy”) between a direction of the travel traveling line Ld and a traveling direction of the vehicle VA.

The DSECU 10 calculates a target steering angle θ* by applying the center distance Dc, the yaw angle θy, and the curvature C to the following equation (2). Each of “Klta1”, “Klta2”, and “Klta3” in the equation (2) is a predetermined control gain.

θ*=Klta1·C+Klta2·θy+Klta3·Dc (2)

The DSECU 10 transmits, to the steering ECU 40, a signal (a steering command) indicative of the target steering angle θ*. The steering ECU 40 drives the steering motor in such a manner that an actual steering angle θ coincides with the target steering angle θ*. Accordingly, the actual steering angle θ of the vehicle VA becomes equal to the target steering angle θ*.

The DSECU 10 may calculate a target yaw rate YRtgt by applying the center distance Dc, the yaw angle θy, and the curvature C to the following equation (2A) to execute the lane tracing control. Each of “Klta11”, “Klta12”, and “Klta13” in the equation (2A) is the control gain. The target yaw rate YRtgt is a yaw rate which enables the vehicle VA to travel along the target traveling line Ld.

YRtgt=Klta11·Dc+Klta12·θy+Klta13·C (2A)

In this case, the DSECU 10 calculates a target steering torque TRtgt which is required to realize the target yaw rate YRtgt, based on the target yaw rate YRtgt and the yaw rate YR measured by the yaw rate sensor 16 (hereinafter, may be referred to as “an actual yaw rate YR”).

More specifically, a lookup table has been stored in the DSECU 10 in advance. The look up table defines a relationship among “a deviation between the target yaw rate YRtgt and the actual yaw rate YR”, the vehicle speed Vs, and the target steering torque TRtgt. The DSECU 10 acquires the target steering torque TRtgt by applying “the deviation between the target yaw rate YRtgt and the actual yaw rate YR” and the vehicle speed Vs to that lookup table. Thereafter, the DSECU 10 controls the steering motor 43 via the steering ECU 40 in such a manner that the actual steering torque TR measured by the steering torque sensor 42 coincides with the target steering torque TRtgt.

The above described lane tracing control is executed on the premise that the cruise control is being executed. In other words, the lane tracing control is not started when the cruise control is not being executed.

3: Speed Management Control

When the vehicle VA is traveling in a curve section while the DSECU 10 is executing the cruise control, the DSECU 10 controls the vehicle speed Vs by adjusting the acceleration of the vehicle VA so that the vehicle VA can travel in the curve section stably. This control is referred to as a speed management control. That is, the DSECU 10 executes the speed management control for controlling a vehicle's traveling state in such a manner that the vehicle speed Vs does not exceed “a target vehicle speed serving as an upper limit vehicle speed” which will be described later while the vehicle VA is traveling in the curve section Cv.

The DSECU 10 determines the above described target traveling line Ld based on the camera image obtained by the camera device 12. Thereafter, the DSECU 10 calculates, as a present curvature CC, the curvature C of the target traveling line Ld at the front end center position CL of the vehicle VA. Furthermore, the DSECU 10 calculates, as a future curvature FC, the curvature C of the target traveling line at a future position FL (referring to FIG. 3) which is a position located on the target traveling line Ld and a predetermined distance D away from the front end center position CL in a traveling direction of the vehicle VA.

When the front end center position CL is not on the target traveling line Ld, the DSECU 10 acquires a virtual target traveling line by translating (parallelly shifting) the target traveling line Ld so that the translated traveling line passes through the front end center position CL of the vehicle VA. Thereafter, the DSECU 10 calculates, as the future curvature FC, the curvature C of the virtual target traveling line at the future position FL which is a position located on the virtual target traveling line Ld and the predetermined distance D away from the front end center position CL in the traveling direction of the vehicle VA.

In the case where the present curvature CC and the future curvature FC have satisfied a condition which is to be satisfied when the vehicle VA enters (or is about to enter) the curve section Cv, the DSECU 10 calculates, as the target vehicle speed, the upper limit value/speed of the vehicle speed Vs in a period for which the vehicle VA runs/travels in the curve section Cv. Thereafter, the DSECU 10 calculates the target acceleration ACtgt based on the vehicle speed Vs and the target vehicle speed. The DSECU 10 controls the vehicle VA in such a manner that the actual acceleration dg approaches the target acceleration ACtgt. Hereby, the vehicle VA is controlled in such a manner the vehicle speed Vs does exceed the target vehicle speed. Therefore, the vehicle VA can travel in the curve section stably which the vehicle VA is about to enter or the vehicle VA has been entering.

(Outline of Operation)

The lane tracing control starts to be executed when the driver operates the lane tracing control operation switch 15 in a situation in which the cruise control is being executed. Furthermore, the speed management control is executed in a situation in which the cruise control is being executed. That is, the speed management control is executed in any one of a first situation and a second situation described below.
The first situation is a situation in which the cruise control is being executed and the lane tracing control is not executed.
The second situation is a situation in which both of the cruise control and the lane tracing control are being executed.

In the first situation, the lane tracing control is not executed. Therefore, in the first situation, the driver needs to perform a steering operation so as to have the vehicle VA travel in the self-lane. In contrast, in the second situation, the lane tracing control is executed. Therefore, in the second situation, the driver does not have to perform the steering operation. It is now assumed that the speed management control which is executed in the first situation is the same as the speed management control which is executed in the second situation. Under this assumption, “a possibility that the speed management control executed in the second situation causes the driver to feel uneasy as to whether or not the vehicle VA can travel in the curve section stably (whether or not the vehicle VA can negotiate the curve section)” is higher than “a possibility that the speed management control executed in the first situation causes the driver to feel uneasy as to the same, because the driver does not perform the steering operation in the second situation.

In view of the above, the present control device executes the speed management control in the second situation in such a manner that a movement of the vehicle VA is slower/gentler/milder (that is, the vehicle VA can travel in the curve section more slowly/gently) in the second situation than in the first situation. The speed management control executed in the first situation is referred to as “a first speed management control”. The speed management control executed in the second situation is referred to as “a second speed management control”.

As described above, in the speed management control, the vehicle's traveling state is controlled in such a manner that the vehicle speed Vs of when the vehicle VA is traveling in the curve section does not exceed the target vehicle speed Vstgt serving as the upper limit vehicle speed. The present control device sets the target vehicle speed Vstgt which is used through the second speed management control to a value smaller than the target vehicle speed Vstgt which is used through the first speed management control, so that the movement/behavior of the vehicle VA in the second speed management control is made slower/gentler than that of the vehicle VA in the first speed management control.

Hereby, the vehicle speed Vs of when the vehicle VA travels in the curve section in the second situation is lower than the vehicle speed Vs of when the vehicle VA travels in the curve section in the first situation. Therefore, the possibility that the driver feels uneasy when the vehicle VA travels in the curve section in the second situation can be lowered.

(Operation)

The present control device calculates, as the present curvature CC, the curvature C of the target traveling line Ld at the front end center position CL of the vehicle CA. When the front end center position CL is not on the target traveling line Ld, the present control device calculates, as the present curvature CC, the curvature C of the virtual target traveling line at the front end center position CL. The virtual target traveling line is acquired by translating the target traveling line Ld so that the translated traveling line passes through the front end center position CL of the vehicle VA.

Furthermore, the present control device determines whether or not both of the future curvature FC and the present curvature CC satisfy a curvature start condition. The curvature start condition becomes satisfied when the future position FL reaches a position which is regarded as a start position of the curve section Cv (referring to a curve entrance CvEn shown in FIG. 3). When both of the future curvature FC and the present curvature CC satisfy the curvature start condition, the present control device determines that the vehicle VA is about to enter the curve section Cv, and executes (starts) the speed management control.

As described above, the distance between the future point FL and the front end center position CL is the predetermined distance D. In an example shown in FIG. 3, both of the future curvature FC and the present curvature CC satisfy the curvature start condition at a time point t1 at which the front end center position CL of the vehicle VA reaches a position the predetermined distance D away from the curve entrance CvEn on the vehicle's side (toward the vehicle VA). Therefore, the present control device starts the speed management control at the time point t1.

Meanwhile, a first lateral G(R) map and a second lateral G(R) map have been stored in the ROM of the present control device. The first lateral G(R) map is a lookup table which defines “an upper limit value of a lateral G (or an upper limit lateral G) which is used through the first speed management control” for (with respect to) a curvature radius (=1/curvature C) of the curve section Cv. The lateral G means a magnitude of the acceleration in the vehicle width direction of the vehicle VA. The second lateral G(R) map is a lookup table which defines an upper limit value of the lateral G (or an upper limit lateral G) which is used through the second speed management control for (with respect to) the curvature radius (=1/curvature C) of the curve section Cv.

As shown in a block BL1 in FIG. 3, the first lateral G(R) map defines the upper limit lateral G in such a manner the upper limit lateral G becomes smaller as the curvature radius R of the curve section Cv becomes larger (that is, the upper limit lateral G becomes smaller as the curve section Cv becomes gentler). In contrast, as shown by a solid line in a block BL2 in FIG. 3, the second lateral G(R) map defines the upper limit lateral G in such a manner that the upper limit lateral G is a constant value regardless of the curvature radius R of the curvature Cv. In addition, the second lateral G(R) map defines the upper limit lateral G in such a manner the upper limit lateral G defined by the second lateral G(R) map is smaller than the upper limit lateral G defined by the first lateral G(R) map for (with respect to) an arbitrary curvature radius R. Note, however that, as shown by a dotted line in a block BL3 in FIG. 3, the second lateral G(R) map may define the upper limit lateral G in such a manner that the upper limit lateral G defined by the second lateral G(R) map becomes smaller as the curvature radius R becomes larger, as long as the upper limit lateral G (a second upper limit lateral G) defined by the second lateral G(R) map is kept smaller than the upper limit lateral G (a first upper limit lateral G) defined by the first lateral G(R) map for (with respect to) an arbitrary curvature radius R. It should be noted that the upper limit lateral G defined by the first lateral G(R) map is shown by a two-dot chain line in the block BL2 in FIG. 3 for reference' sake.

The present control device determines whether the present situation matches the first situation or the second situation at the time point t1. When the present situation at the time point t1 matches the first situation, the present control device executes the first speed management control using the first lateral G(R) map. More specifically, the present control device acquires the upper limit lateral G by applying “a future curvature radius FR acquired based on the future curvature FC” to the first lateral G(R) map. Thereafter, the present control device executes the first speed management control for controlling the vehicle speed Vs in such a manner that the lateral G which is actually acting on the vehicle VA (hereinafter, sometimes referred to as “an actual lateral G”) does exceed the upper limit lateral G.

The “lateral G acting on the vehicle VA when the vehicle VA travels in the curve section Cv” can be calculated by applying the curvature radius R of the curve section Cv and the vehicle speed Vs to the following equation (3).

Lateral G=Vs²/R (3)

The present control device acquires the target vehicle speed Vstgt by applying the acquired upper limit lateral G and the future curvature radius FR (as R) to the above equation (3). The target vehicle speed Vstgt is a target value of the vehicle speed Vs at a time point at which the front end center position CL of the vehicle VA moves/runs the predetermined distance D from the present position of the vehicle VA. In the first speed management control, the vehicle speed Vs is controlled in such a manner the vehicle speed Vs at the time point at which the front end center position CL of the vehicle VA moves/runs the predetermined distance D from the present position coincides with the target vehicle speed Vstgt.

In contrast, when the situation at the time point t1 matches the second situation, the present control device executes the second speed management control using the second lateral G(R) map. Similarly to the first speed management control, the present control device acquires the upper limit lateral G by applying the future curvature radius FR to the second lateral G(R) map. Subsequently, the present control device acquires the target vehicle speed Vstgt by applying the acquired upper limit lateral G and the future curvature radius FR (as R) to the above equation (3). Thereafter, similarly to the first speed management control, in the second speed management control, the present control device controls the vehicle speed Vs in such a manner that the vehicle speed Vs at the time point at which the front end center position CL of the vehicle VA moves/runs the predetermined distance D from the present position coincides with the target vehicle speed Vstgt.

As described above, the upper limit lateral G defined by the second lateral G(R) map is smaller than the upper limit lateral G defined by the first lateral G(R) map (with respect to an arbitrary curvature radius R). Therefore, “the vehicle speed Vs in the curve section Cv of when the second speed management control is being executed” is lower than “the vehicle speed Vs in the curve section Cv of when the first speed management control is being executed”. Accordingly, the present control device can lower the possibility that driver feels uneasy in the second situation in which both of the cruise control and the lane tracing control are being executed, compared with the above described conventional device which executes the speed management control in the second situation which is the same as the speed management control in the first situation.

The present control device determines whether or not both of the future curvature FC and the present curvature CC satisfy a curvature end condition. The curvature end condition becomes satisfied when the future position FL reaches a position which is regarded as an end position of the curve section Cv (referring to a curve exit CvEx shown in FIG. 3). When both of the future curvature FC and the present curvature CC satisfy the curvature end condition, the present control device determines that the vehicle VA is about to enter a straight lane from the curve section Cv, and ends the speed management control. In the example shown in FIG. 3, the present control device determines that both of the future curvature FC and the present curvature CC satisfy the curvature end condition to end the speed management control at a time point t2 at which the front end center position CL of the vehicle VA reaches a position the predetermined distance D away from the curve exit CvEx in the vehicle's side (toward the vehicle VA).

(Specific Operation)

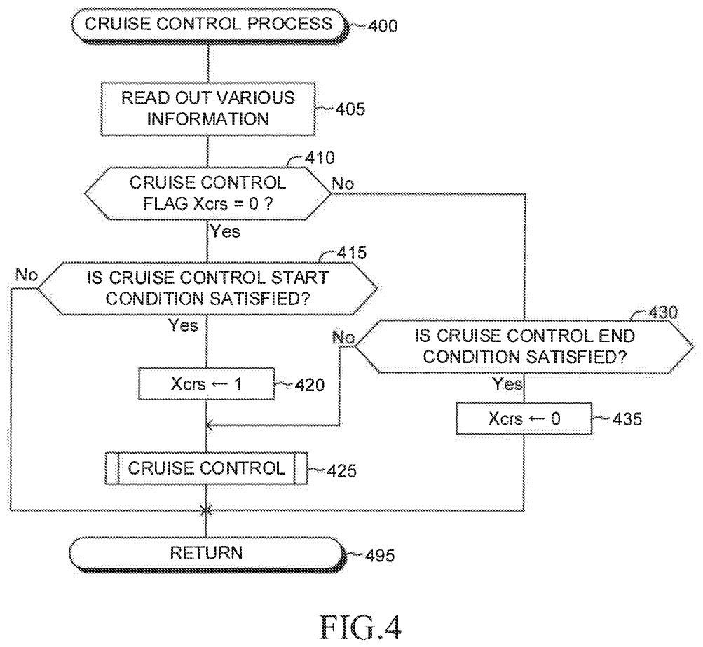

An operation of the DSECU 10 of the present control device will be described specifically with reference to FIGS. 4 to 8.

<Cruise Control Routine>

The CPU of the DSECU 10 (hereinafter, the term “CPU” means the CPU of the DSECU 10 unless otherwise specified) is configured to execute a routine (a cruise control routine) represented by a flowchart shown in FIG. 4, every time a predetermined time elapses.

When a predetermined timing has come, the CPU starts processes from Step 400 shown in FIG. 4, and proceeds to Step 405 to read out (obtain) information from various devices and various sensors. Thereafter, the CPU proceeds to Step 410.

The CPU determines whether or not a value of a cruise control flag Xcrs is “1” at Step 410. The CPU sets the value of the cruise control flag Xcrs to “1” when a cruise control start condition described later becomes satisfied. The CPU sets the value of the cruise control flag Xcrs to “0” when a cruise control end condition descried later becomes satisfied. Furthermore, the CPU sets the value of the cruise control flag Xcrs to “0” though a initialization routine which the CPU executes when the driver performs an operation for changing a position of an ignition key switch (now shown) of the vehicle VA from an off-position to an on-position.

When the value of the cruise control flag Xcrs is “0”, the CPU makes a “Yes” determination at Step 410, and proceeds to Step 415. At Step 415, the CPU determines whether or not the cruise control start condition for staring the cruise control is satisfied. More specifically, the CPU determines that the cruise control start condition becomes satisfied when the CPU receives the cruise control start signal from the cruise control operation switch 14.

The cruise control start condition may include conditions (additional conditions) other the above condition. For example, the cruise control start condition may include a condition that a lens of the camera device 12 is not clouded, and a condition that a shift lever (not shown) is located at a drive range (a “D” range). The CPU determines that the cruise control start condition becomes satisfied when all of those conditions become satisfied.

When the cruise control start condition is not satisfied, the CPU makes a “No” determination at Step 415, and proceeds to Step 495 to tentatively terminate the present routine.

On the other hand, when the cruise control start condition is satisfied at the time point at which the CPU proceeds to Step 415, the CPU makes a “Yes” determination at Step 415, and proceeds to Step 420.

The CPU sets the value of the cruise control flag Xcrs to “1” at Step 420, and proceeds to Step 425. The CPU calculates the ACC target acceleration GACCtgt which is used in the cruise control at Step 425. Thereafter, the CPU transmits the ACC target acceleration GACCtgt to the engine ECU 20 and the brake ECU 30 as the driving support target acceleration GStgt, when the CPU is not executing the speed management control described later (Xspm=0). This causes the cruise control to be executed. In contrast, the CPU does not transmit the ACC target acceleration GACCtgt to the engine ECU 20 or the brake ECU 30 at Step 425 (referring to Step 650 described later), when the CPU is executing the speed management control (Xspm=1). Thereafter, the CPU proceeds to Step 495 to tentatively terminate the present routine.

When the CPU proceeds to Step 410 in the present routine executed after the CPU has set the value of the cruise control flag Xcrs to “1” at Step 420, the CPU makes a “No” determination at Step 410 to proceed to Step 430. The CPU determines whether or not “the cruise control end condition for ending the cruise control” is satisfied at Step 430. More specifically, the CPU determines that the cruise control end condition becomes satisfied when the CPU receives the cruise control end signal from the cruise control operation switch 14.

The cruise control end condition may include conditions (additional conditions) other the above condition. For example, the cruise control end condition may include a condition that the lens of the camera device 12 becomes clouded, and a condition that the shift lever (not shown) is moved to be located at one of ranges other than the drive range. The CPU determines that the cruise control end condition becomes satisfied when at least one of these conditions becomes satisfied.

When the cruise control end condition is not satisfied, the CPU makes a “No” determination at Step 430, and proceeds to Step 425 to execute the above described process.

On the other hand, when the cruise control end condition is satisfied at the time point at which the CPU proceeds to Step 430, the CPU makes a “Yes” determination at Step 430 to proceed to Step 435. The CPU sets the value of the cruise control flag Xcrs to “0” at Step 435, and proceeds to Step 495 to tentatively terminate the present routine. In this case, the CPU does not transmits the ACC target acceleration GACCtgt to the engine ECU 20 or the brake ECU 30.

<Lane Tracing/Keeping Control Routine>

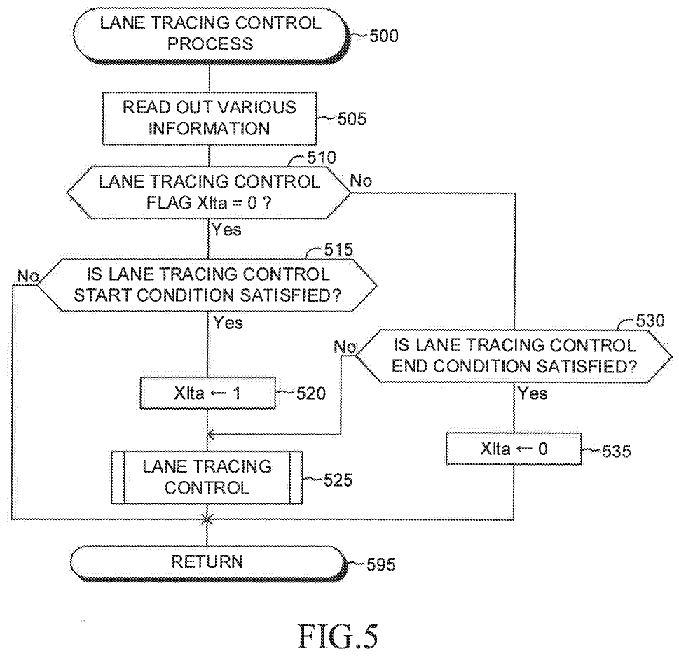

The CPU is configured to execute a routine (a lane tracing control routine) represented by a flowchart shown in FIG. 5, every time a predetermined time elapses.

When a predetermined timing has come, the CPU starts processes from Step 500 shown in FIG. 5, and proceeds to Step 505 to read out (obtain) information from various devices and various sensors. Thereafter, the CPU proceeds to Step 510.

The CPU determines whether or not a value of a lane tracing control flag Xlta is “0” at Step 510. The CPU sets the value of the lane tracing control flag Xlta to “1” when a lane tracing control start condition described later becomes satisfied. The CPU sets the value of the lane tracing control flag Xlta to “0” when a lane tracing control end condition described later becomes satisfied. Furthermore, the CPU sets the value of the lane tracing control flag Xlta to “0” though the initialization routine described above.

When the value of the lane tracing control flag is “0”, the CPU makes a “Yes” determination at Step 510 to proceed to Step 515. The CPU determines whether or not the lane tracing control start condition is satisfied at Step 515. More specifically, the CPU determines that the lane tracing control start condition becomes satisfied when both the following conditions (A1) and (A2) become satisfied.

(A1) The value of the cruise control flag Xcrs is “1”.

(A2) The CPU receives the lane tracing control start signal from the lane tracing control operation switch 15.

The lane tracing control start condition may include conditions other than the above conditions. For example, the lane tracing control start condition may include the two conditions described as the additional conditions of the cruise control start condition. In this case, the CPU determines that the lane tracing control start condition becomes satisfied when all of the conditions become satisfied.

The CPU determines that the lane tracing control start condition is not satisfied when at least one of the condition (A1) and (A2) is not satisfied. In this case, the CPU makes a “No” determination at Step 515, and proceeds to Step 595 to tentatively terminate the present routine.

On the other hand, when both of the conditions (A1) and (A2) are satisfied at a time point at which the CPU proceeds to Step 515, the CPU determines that the lane tracing start condition is satisfied. In this case, the CPU makes a “Yes” determination at Step 515 to proceed to Step 520.

The CPU sets the value of the lane tracing control flag Xlta to “1” at Step 520, and proceeds to Step 525. At Step 525, the CPU executes the lane tracing control, by calculating the target steering angle θ* as described above to transmit the target steering angle θ* to the steering ECU 40. Thereafter, the CPU proceeds to Step 595 to tentatively terminate the present routine.

When the CPU proceeds to Step 510 in the present routine executed after the CPU has set the value of the lane tracing control flag Xlta to “1” at Step 520, the CPU makes a “No” determination at Step 510, and proceeds to Step 530. The CPU determines whether or not the lane tracing control end condition is satisfied at Step 530.

More specifically, the CPU determines that the lane tracing control end condition becomes satisfied when at least one of the following conditions (A3) and (A4) becomes satisfied.

(A3) The value of the cruise control flag Xcrs is “0”.

(A4) The CPU receives the lane tracing control end signal from the lane tracing control operation switch 15.

The lane tracing control end condition may include conditions other than the above conditions. For example, the lane tracing control end condition may include the two conditions described as the additional conditions as the lane tracing control start condition. In this case, the CPU determines that the lane tracing control end condition becomes satisfied when at least one of the two conditions becomes unsatisfied.

The CPU determines that the lane tracing control end condition is not satisfied when none of the conditions (A3) and (A4) is satisfied. In this case, the CPU makes a “No” determination at Step 530, and proceeds to Step 525 to continue executing the lane tracing control by executing the above described process.

On the other hand, when at least one of the conditions (A3) and (A4) is satisfied at the time point at which the CPU proceeds to Step 530, the CPU determines that the lane tracing control end condition is satisfied. In this case, the CPU makes a “Yes” determination at Step 530 to proceed to Step 535. The CPU sets the value of the lane tracing control flag Xlta to “0” at Step 535, and proceeds to Step 595 to tentatively terminate the present routine. In this case, the CPU does not execute the process of Step 525, so that the lane tracing control is ended.

<Speed Management Control Routine>

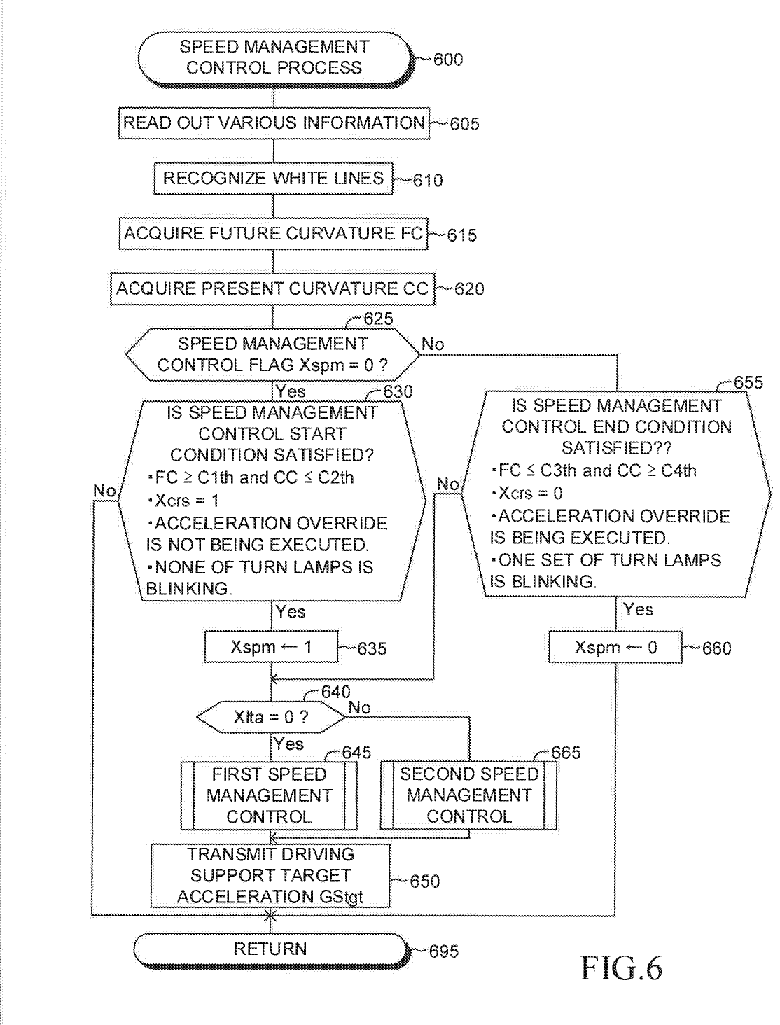

The CPU is configured to execute a routine (a SPM routine) represented by a flowchart shown in FIG. 6, every time a predetermined time elapses.

When a predetermined timing has come, the CPU starts processes from Step 600 shown in FIG. 6 to execute Steps 605 through 620 in order, and proceeds to Step 625.

Step 605: The CPU reads out (obtain) information from various devices and various sensors.

Step 610: The CPU recognizes/extracts, based on the image represented by the image data, the left white line LL and the right white line RL which segment the road into the traveling lane (the self-lane) in which the vehicle VA is currently traveling. A process for recognizing a white line is a well-known process. For example, such a process is disclosed in Japanese Patent Application Laid-open No. 2013-105179.

Step 615: The CPU acquires the future curvature FC based on the white lines which are recognized at Step 610 as described above.

Step 620: The CPU acquires the present curvature CC based on the white lines which are recognized at Step 610 as described above.

It should be noted that a process for calculating the curvature radius R at an arbitrary position on the white line based on the white line is a well-known process. For example, such a process is disclosed in Japanese Patent Application Laid-open No. 2011-169728. The CPU calculates, as the curvature C, a reciprocal of the curvature radius R which is calculated according to the well-known method.

Step 625: The CPU determines whether or not a value of a speed management control flag Xspm is “0”. The CPU sets the value of the speed management control flag Xspm to “1” when a speed management control start condition described later becomes satisfied. The CPU sets the value of the speed management control flag Xspm to “0” when a speed management control end condition described later becomes satisfied. Furthermore, the CPU sets the value of the speed management control flag Xspm to “0” though the initialization routine described above.

When the value of the speed management control flag Xspm is “0” (for example, when the speed management control has not been executed yet), the CPU makes a “Yes” determination at Step 625, and proceeds to Step 630.

At Step 630, the CPU determines whether or not the speed management control start condition is satisfied. More specifically, the CPU determines that the speed management control start condition becomes satisfied when all of the following conditions (B1) through (B4) become satisfied. The CPU is configured to receive, from the engine ECU 20, a signal indicative of whether or not the acceleration override is being executed. Furthermore, the CPU receives a signal indicative of whether or not two sets of unillustrated turn signal lamps (turn lamps) of the vehicle VA are blinking intermittently from an unillustrated turn signal lamp control ECU.

(B1) The above described curvature start condition is satisfied. More specifically, “a condition that the future curvature FC is equal to or larger than a first threshold curvature C1th and the present curvature CC is equal to or smaller than a second threshold curvature C2th” is satisfied. The second threshold curvature C2th has been set to a value smaller than the first threshold curvature C1th.

(B2) The value of the cruise control flag Xcrs is “1”.

(B3) The acceleration override is not being executed.

(B4) None of the turn signal lamps is blinking intermittently.

The CPU determines that the speed management control start condition is unsatisfied when at least one of the conditions (B1) through (B4) is unsatisfied. In this case, the CPU makes a “No” determination at Step 630, and proceeds to Step 695 to tentatively terminate the present routine. For example, if the condition (B3) has been unsatisfied, it is considered that the driver wants to accelerate the vehicle VA by operating the acceleration pedal by himself/herself. Therefore, the CPU does not execute the speed management control. If the condition (B4) has been unsatisfied, it is considered that the vehicle VA is turning or is about to turn right or left. Therefore, the CPU does not execute the speed management control.

On the other hand, when all of the conditions (B1) through (B4) are satisfied at the time point at which the CPU proceeds to Step 630, the future position FL of the vehicle VA reaches the curve entrance CvEn so that the vehicle VA is about to enter the curve section while the cruise control is being executed. In this case, the CPU determines that the speed management start condition becomes satisfied. That is, the CPU makes a “Yes” determination at Step 630 to proceed to Step 635.

When the speed management control start condition is satisfied so that the speed management control is started, the CPU sets the value of the speed management control flag Xspm to “1” at Step 635, and proceeds to Step 640. The CPU determines whether or not the value of the lane tracing control flag Xlta is “0” at Step 640.

When the value of the lane tracing control flag Xlta is “0” (in other words, when the lane tracing control is not being executed), that is, when the cruise control is being executed and the lane tracing control is not being executed, the CPU makes a “Yes” determination at Step 640, and executes Steps 645 and 650 described below in this order. Thereafter, the CPU proceeds to Step 695 to tentatively terminate the present routine.

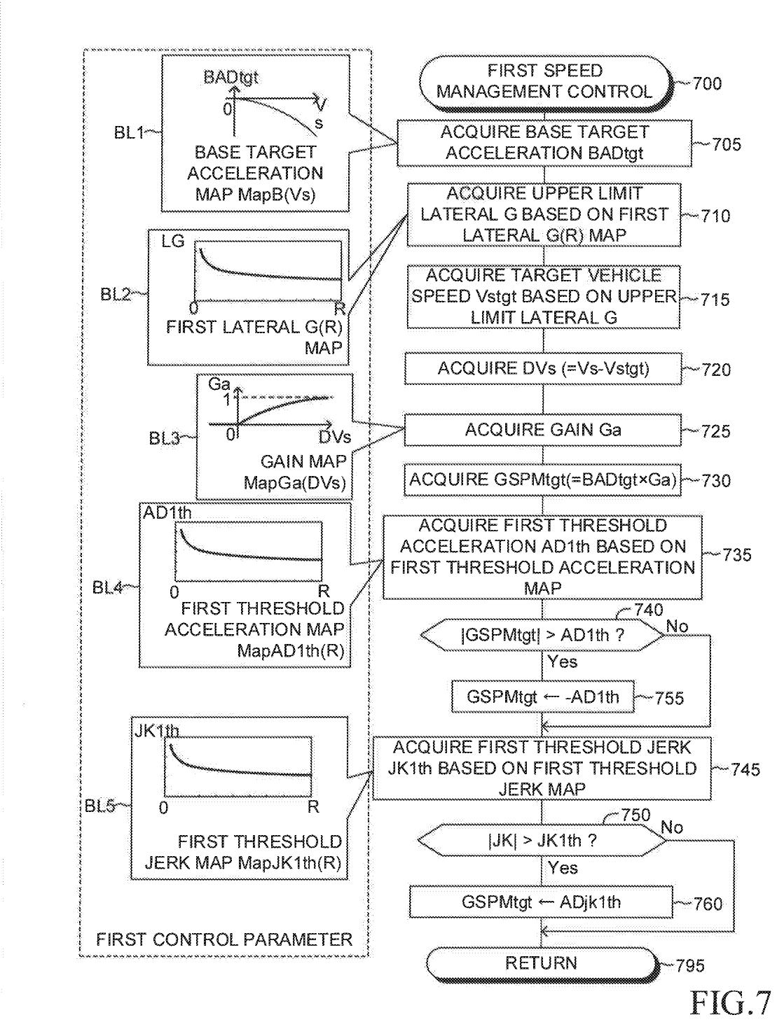

Step 645: The CPU executes the first speed management control which will be described later in detail with reference to FIG. 7.

Step 650: The CPU determines, as the driving support target acceleration GStgt, either one of the SPM target acceleration GSPMtgt calculated at the present time point (the SPM target acceleration GSPMtgt acquired at Step 645 described later) and the above ACC target acceleration GACCtgt, whichever is smaller. The CPU transmits the driving support target acceleration GStgt to the engine ECU 20 and the brake ECU 30.

The engine ECU 20 increases or decreases the target throttle valve opening degree TAtgt in such a manner that the actual acceleration dg coincides with the driving support target acceleration GStgt transmitted from the DSECU 10.

When the actual acceleration dg is larger than the driving support target acceleration GStgt at a time point at which the target throttle valve opening degree TAtgt becomes equal to “0”, the CPU controls/generates the brake force using the brake actuator 34 in such a manner that the actual acceleration dg coincides with the driving support target acceleration GStgt, so as to decelerate the vehicle VA. The brake ECU 30 determines, as the final target acceleration, either one of the target acceleration GBPtgt corresponding to the brake pedal operation amount BP and the driving support target acceleration GStgt, whichever is smaller. Thereafter, the brake ECU 30 controls the brake actuator 34 based on the determined final target acceleration. That is, the brake ECU 30 is configured to execute the brake override.

When the CPU proceeds to Step 625 in the present routine after the CPU sets the value of the speed management control flag Xspm to “1” at Step 635 in the routine previously executed, the CPU makes a “No” determination at Step 625, and proceeds to Step 655. The CPU determines whether or not the speed management control end condition is satisfied at Step 655. More specifically, the CPU determines that the speed management control end condition becomes satisfied when at least one of the following conditions (B5) through (B8) becomes satisfied.

(B5) A curvature end condition is satisfied. More specifically, “a condition that the future curvature FC is equal to or smaller than a third threshold curvature C3th and the present curvature CC is equal to or larger than a fourth threshold curvature C4th” is satisfied. The fourth threshold curvature C4th has been set to a value larger than the third threshold curvature C3th.

(B6) The value of the cruise control flag Xcrs is “0”.

(B7) The acceleration override is being executed.

(B8) One set of the turn lamps is blinking intermittently.

The third threshold curvature C3th may have been set to the same value as the second threshold curvature C2th. The fourth threshold curvature C4th may have been set to the same value as the first threshold curvature C1th.

When none of the conditions (B5) through (B8) is satisfied, the CPU determines that the speed management control end condition has not been satisfied yet. In this case, the CPU makes a “No” determination at Step 655, and proceeds to Step 640.

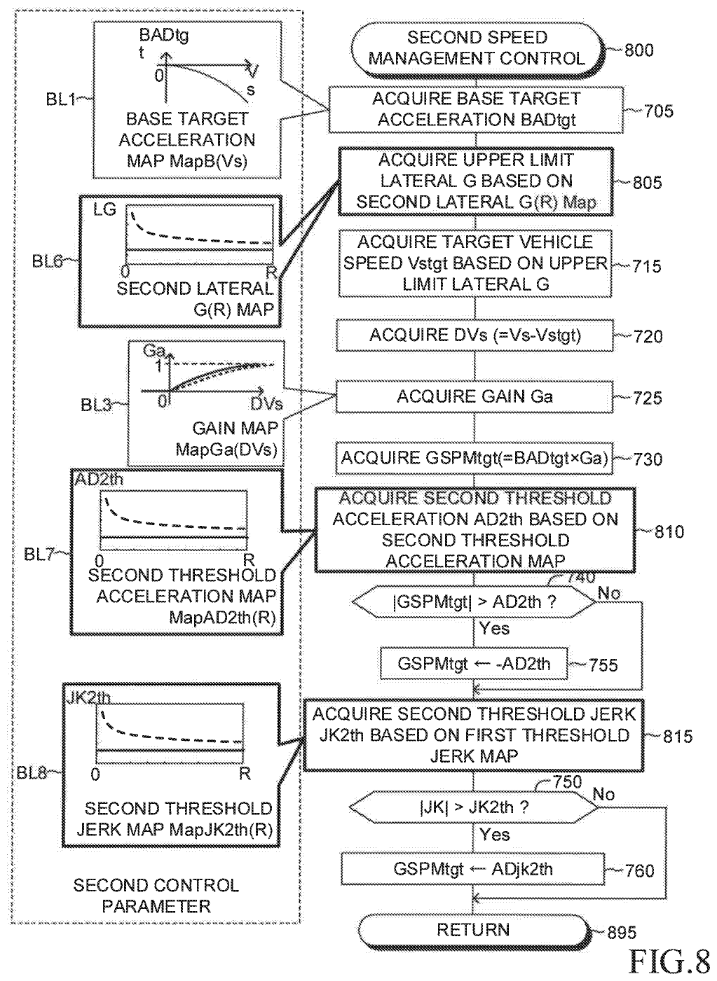

Meanwhile, when the value of the lane tracing control flag Xlta is “1”, that is, when “the second situation in which both of the cruise control and the lane tracing control are being executed” is occurring, at the time point at which the CPU proceeds to Step 640, the CPU makes a “No” determination at Step 640, and proceeds to Step 665. At Step 665, the CPU executes the second speed management control which will be described later in detail with reference to FIG. 8, and proceeds to Step 650. At Step 650, the CPU determines, as the driving support target acceleration GStgt, either one of the SPM target acceleration GSPMtgt calculated at the present time point (the SPM target acceleration GSPMtgt acquired at Step 665) and the above ACC target acceleration GACCtgt, whichever is smaller, and transmits the determined driving support target acceleration GStgt to the engine ECU 20 and the brake ECU 30. Thereafter, the CPU proceeds to Step 695 to tentatively terminate the present routine.

On the other hand, when at least one of the conditions (B5) through (B8) is satisfied at the time point at which the CPU proceeds to Step 655, the CPU determines that the speed management control end condition is satisfied. That is, in this case, the CPU makes a “Yes” determination at Step 655, and proceeds to Step 660. The CPU sets the value of the speed management control flag Xspm to “0” at Step 660, and proceeds to Step 695 to tentatively terminate the present routine. For example, when the condition (B8) has become satisfied, the future position FL of the vehicle VA has reached the curve exit CvEx. In this case, the vehicle VA is about to exit the curve section while the cruise control is being executed. Therefore, the CPU ends the speed management control.

<First Speed Management Control>

When the CPU proceeds to Step 645 shown in FIG. 6, the CPU executes a subroutine represented by a flowchart shown in FIG. 7. That is, the CPU starts processes from Step 700 shown in FIG. 7 to execute Steps 705 through 740 in order.

Step 705: The CPU acquires a base target acceleration BADtgt by applying the vehicle speed Vs to a base target acceleration map MapB(Vs). As shown a block BL1 in FIG. 7, according to the base target acceleration map MapB(Vs), the CPU determines the base target acceleration BADtgt in such a manner that the base target acceleration BADtgt is equal to or smaller than “0” and becomes smaller (the magnitude of the deceleration becomes larger) as the vehicle speed Vs becomes higher.

Step 710: The CPU acquires the upper limit lateral G by applying the future curvature radius FR (FR=1/FC) corresponding to “the future curvature FC which is acquired at Step 615 shown in FIG. 6” to the first lateral G(R) map (referring to a block BL2 in FIG. 7). According to the first lateral G(R) map, the CPU determines the upper limit lateral G in such a manner that the upper limit lateral G becomes smaller as the curvature radius R becomes larger. The upper limit lateral G acquired based on the first lateral G(R) map at Step 710 shown in FIG. 7 may be referred to as “a first upper limit lateral G” for convenience.

Step 715: The CPU acquires the target vehicle speed Vstgt which is the upper limit vehicle speed by applying the future curvature radius FR and “the upper limit lateral G acquired at Step 710” to the above equation (3). More specifically, the CPU calculates, as the target vehicle speed Vstgt, a square root of “a value which acquired by multiplying the future curvature radius FR and the upper limit lateral G”. The target vehicle speed Vstgt calculated at Step 715 shown in FIG. 7 may be referred to as “a first target vehicle speed” for convenience.

Step 720: The CPU acquires a subtraction vehicle speed DVs (DVs=Vs−Vstgt) by subtracting “the target vehicle speed Vstgt acquired at Step 715” from “the vehicle speed Vs”.

Step 725: The CPU acquires the gain Ga by applying the subtraction vehicle speed DVs acquired at Step 720 to a gain map MapGa(DVs) (referring to a block BL3 shown in FIG. 3). According to the gain map MapGa(DVs), the CPU determines the gain Ga in such a manner that “the gain Ga is a value which is equal to or larger than “0” and equal to or smaller than “1” and becomes larger as the subtraction vehicle DVs becomes larger. When the subtraction vehicle speed DVs is equal to or smaller than “0” (in other word, when the vehicle speed Vs is equal to or lower than the target vehicle speed Vstgt), the vehicle VA needs not to be decelerated. Therefore, when the subtraction vehicle speed DVs is equal to or smaller than “0”, the CPU sets the gain Ga to “0”. In contrast, when the vehicle speed Vs is higher than the target vehicle speed Vstgt, the vehicle VA is decelerated in such a manner that the vehicle speed Vs does not exceed the target vehicle speed Vstgt until the vehicle speed Vs coincides with the target vehicle speed Vstgt.

Step 730: The CPU acquires the SPM target acceleration GSPMtgt by multiplying the base target acceleration BADtgt acquired at Step 705 and the gain GA acquired at Step 725. The SPM target acceleration GSPMtgt is equal to or smaller than “0”, because the base target acceleration BADtgt is equal to or smaller than “0”. Therefore, the SPM target BADtgt indicates a target deceleration.

Step 735: The CPU acquires a first threshold acceleration AD1th by applying the future curvature radius FR to a first threshold acceleration map MapAD1th(R). As shown in a block BL 4 in FIG. 7, according to the first threshold acceleration map MapAD1th(R), the CPU determines the first threshold acceleration AD1th in such a manner that the first threshold acceleration AD1th is equal to or larger than “0” and becomes smaller as the curvature radius R becomes larger.

Step 740: The CPU determines whether or not a magnitude (|GSPMtgt|) of the SPM target acceleration GSPMtgt acquired at Step 730 is larger than the first threshold acceleration AD1th acquired at Step 735. When the magnitude (|GSPMtgt|) is equal to or smaller than the first threshold acceleration AD1th, the CPU makes a “No” determination at Step 740, and proceeds to Step 745 directly.

At Step 745, the CPU acquires a first threshold jerk JK1th by applying the future curvature radius FR to a first threshold jerk map MapJK1th(R). As shown in a block BL 5 in FIG. 7, according to the first threshold jerk JK1th, the CPU determines the first threshold jerk JK1th in such a manner that the first threshold jerk JK1th is equal to or larger than “0” and becomes smaller as the curvature radius R becomes larger.

The CPU determines whether or not a magnitude (|JK|) of the Jerk JK is larger than the first threshold jerk JK1th at Step 750. The jerk JK is a derivation value of the acceleration of the vehicle VA. The CPU calculates the jerk JK according to the following equation (4).

JK={GSPMtgt(P)−GStgt(L)}/t (4)

The “GSPMtgt(P)” in the above equation (4) is the SPM target acceleration GSPMtgt acquired at Step 730 in the present routine which is executed at the present time point. The “GStgt(L)” in the above equation (4) is the driving support target acceleration GStgt which was transmitted at Step 650 in the routine shown in FIG. 6 previously executed at the most recent time point. The “t” in the above equation (4) is an execution interval of the routine shown in FIG. 6.

When the magnitude (|JK|) of the jerk JK is equal to or smaller than the first threshold jerk JK1th, the CPU makes a “No” determination at Step 750 shown in FIG. 7, and proceeds to Step 795 to tentatively terminate the present routine.

When the magnitude (|GSPMtgt|) of the SPM target acceleration GSPMtgt is larger than the first threshold acceleration AD1th at the time point at which the CPU proceeds to Step 740, the CPU makes a “Yes” determination at Step 740, and proceeds to Step 755. The CPU sets the SPM target acceleration GSPMtgt to a value (−AD1th) which is acquired by reversing the sign of the first threshold acceleration AD1th, in order to make the magnitude of the SPM target acceleration GSPMtgt equal to the first threshold acceleration AD1th at Step 755, and proceeds to Step 745.

Hereby, the CPU can prevent a magnitude of the actual acceleration dg from becoming larger than the first threshold acceleration AD1th in a specific period when the vehicle VA is about to enter the curve section Cv and the vehicle VA is traveling in the curve section Cv. In other words, the CPU can prevent an actual deceleration (the magnitude of the acceleration which is a negative value) in the front-rear direction of the vehicle VA from becoming larger than the first threshold acceleration AD1th which is a deceleration, in the specific period. Therefore, the possibility that the driver feels uneasy due to the large deceleration can be lowered.

When the magnitude (|JK|) of the jerk JK is larger than the first threshold jerk JK1th at the time point at which the CPU proceeds to Step 750, the CPU makes a “Yes” determination at Step 750, and proceeds to Step 760.

At Step 760, the CPU acquires a first jerk acceleration ADjk1th which makes the magnitude (|JK|) of the jerk JK equal to or smaller than the first threshold jerk JK1th, sets the new SPM target acceleration to the acquired first jerk acceleration ADjk1th, and proceeds to Step 795 to tentatively terminate the present routine.

More specifically, the CPU calculates the first jerk acceleration ADjk1th by applying the previous driving support target acceleration GStgt(L) and the execution interval t of the routine shown in FIG. 6 to the following equation (5), when the jerk JK is a positive value.

ADjk1th=GStgt(L)+t·JK1th (5)

On the other hand, the CPU calculates the first jerk acceleration ADjk1th by applying the previous driving support target acceleration GStgt(L) and the execution interval t of the routine shown in FIG. 6 to the following equation (6), when the jerk JK is a negative value.

ADjk1th=GStgt(L)−t·JK1th (6)

In the above manner, the jerk JK can be prevented from changing suddenly and greatly, so that the possibility that the driver feels uneasy due to the sudden and great change in the jerk can be lowered.

It should be noted that the CPU may set the SPM target acceleration GSPMtgt to the value (−AD1th) which is acquired by reversing the sign of the first threshold acceleration AD1th, in order to make the magnitude of the SPM target acceleration GSPMtgt equal to the first threshold acceleration AD1th, when the magnitude of the new SPM target acceleration GSPMtgt set at Step 760 is larger than the first threshold acceleration AD1th acquired at Step 735.

<Second Speed Management Control>

When the CPU proceeds to Step 655 shown in FIG. 6, the CPU executes a subroutine represented by a flowchart shown in FIG. 8. That is, the CPU starts processes from Step 800 shown in FIG. 8. In FIG. 8, the same Steps as the Steps shown in FIG. 7 and the same Maps as the Maps shown in FIG. 7 are denoted with common symbols for the Steps and the Maps shown in FIG. 7, and descriptions thereof are omitted.

When the CPU starts the processes from Step 800, the CPU proceeds to Step 705 to acquire the base target acceleration BADtgt, and proceeds to Step 805. At Step 805, the CPU acquires the upper limit lateral G by applying the future curvature radius FR to the second lateral G(R) map. The upper limit lateral G which is acquired according to the second lateral G(R) map at Step 805 shown in FIG. 8 may be referred to as “a second upper limit lateral G”.

As shown in a block BL6 in FIG. 8, the upper limit lateral G (the second upper limit lateral G) defined by the second lateral G(R) map is smaller than the upper limit lateral G (the first upper limit lateral G) defined by the first lateral G(R) map (i.e., the first upper limit lateral G>the second upper limit lateral G). More specifically, the second lateral G(R) map defines the upper limit lateral G (the second upper limit lateral G) in such a manner that the second upper limit lateral G is a constant value regardless of the curvature radius R and is smaller than the upper limit lateral G (the first upper limit lateral G) defined by the first lateral G(R) map. Note, however that, the second lateral G(R) map may define the second upper limit lateral G in such a manner that the second upper limit lateral G becomes smaller as the curvature radius R becomes larger as long as the second upper limit lateral G is kept smaller than the first upper limit lateral G for an arbitrary curvature radius R. It should be noted that the upper limit lateral G defined by the first lateral G(R) map is represented by a dotted line in the block BL6 shown in FIG. 8, for reference.

The CPU executes Steps 715 through 730 after acquiring the upper limit lateral G at Step 805, so that the CPU acquires the SPM target acceleration GSPMtgt based on the target vehicle speed Vstgt which enables the actual lateral G not to exceed the upper limit lateral G acquired at Step 805. It should be noted that “the target vehicle speed Vstgt calculated at Step 715 shown in FIG. 8 which functions as the upper limit vehicle speed” is referred to as “a second vehicle speed” for convenience.

As described above, the upper limit lateral G defined by the second lateral G(R) map is smaller than the upper limit lateral G defined by the first lateral G(R) map. Accordingly, the target vehicle speed Vstgt (the second target vehicle speed) acquired at Step 715 shown in FIG. 8 is smaller than the target vehicle speed Vstgt (the first target vehicle speed) acquired at Step 715 shown in FIG. 7, in the case where the future curvature radius FR is the same value. Hereby, the vehicle speed Vs of when the vehicle VA travels in the curve section Cv under the second situation is smaller than the vehicle speed Vs of when the vehicle VA travels in the curve section Cv under the first situation. The magnitude of the acceleration (the lateral G) acting on the vehicle in the vehicle width direction of the vehicle VA when the vehicle VA travels in the curve section Cv under the second situation is smaller than the magnitude of the acceleration (the lateral G) acting on the vehicle VA in the vehicle width direction of the vehicle VA when the vehicle VA travels in the curve section Cv under the first situation. Therefore, the possibility that the driver feels uneasy under the second situation can be lowered.

The CPU proceeds to Step 810 after executing Step 730 shown in FIG. 8. At Step 810, the CPU acquires a second threshold acceleration AD2th by applying the future curvature radius FR to a second threshold acceleration map MapAD2th(R).

As shown in a block BL8 in FIG. 8, according to the second threshold acceleration map MapAD2th, the CPU determines the second threshold acceleration AD2th in such a manner that the second threshold acceleration AD2th is equal to or larger than “0” and is smaller than the minimum of the first threshold acceleration AD1th defined by the first threshold acceleration map MapAD1th(R). Furthermore, the second threshold acceleration map MapAD2th(R) defines the second threshold acceleration AD2th in such a manner that the second threshold acceleration AD2th is a constant value regardless of the future curvature radius FR. Note, however that, the second threshold acceleration map MapAD2th(R) may define the second threshold acceleration AD2th in such a manner that the second threshold acceleration AD2th becomes smaller as the curvature radius R becomes larger, as long as the second threshold acceleration AD2th is smaller than the first threshold acceleration AD1th for an arbitrary the curvature radius R. It should be noted that the first threshold acceleration AD1th which is defined by the first threshold acceleration map MapAD1th(R) is represented by a dotted line in the block BL7 shown in FIG. 7, for reference.

Thereafter, the CPU proceeds to Step 740 shown in FIG. 8 to determine whether or not the magnitude (|GSPMtgt|) of the SPM target acceleration GSPMtgt acquired at Step 730 shown in FIG. 8 is larger than the second threshold acceleration AD2th acquired at Step 810.

When the above magnitude (|GSPMtgt|) is larger than the second threshold acceleration AD2th, the CPU makes a “Yes” determination at Step 740 shown in FIG. 8, and proceeds to Step 755. The CPU sets the SPM target acceleration GSPMtgt to a value (−AD2th) which is acquired by reversing the sign of the second threshold acceleration AD2th in order to make the magnitude of the SPM target acceleration GSPMtgt equal to the second threshold acceleration AD2th at Step 755, and proceeds to Step 815.

Accordingly, the magnitude of the SPM target acceleration GSPMtgt does not become larger than the second threshold acceleration AD2th which is smaller than the first threshold acceleration AD1th, under the second situation. Therefore, the second speed management control can lower the possibility that the driver feels uneasy due to a great deceleration, compared with the first speed management control.

In contrast, when the magnitude (|GSPMtgt|) of the SPM target acceleration GSPMtgt is equal to or smaller than the second threshold acceleration AD2th, the CPU makes a “No” determination at Step 740 shown in FIG. 8, and proceeds to Step 815.

At Step 815, the CPU acquires the second threshold jerk JK2th by applying the future curvature radius FR to the second threshold jerk map MapJK2th(R), and proceeds to Step 750 shown in FIG. 8. According to the second threshold jerk map MapJK2th(R), as shown in a block BL8 in FIG. 8, the CPU determines the second threshold jerk JK2th in such a manner that the second threshold jerk JK2th is equal to or larger than “0” and is smaller than the minimum of the first threshold jerk JK1th which is defined by the first threshold jerk map MapJK1th(R). The second threshold jerk map MapJK2th(R) defines the second threshold jerk JK2th in such a manner that the second threshold jerk JK2th is a constant value regardless of the future curvature radius FR. Note, however that, the second threshold jerk map MapJK2th(R) may define the second threshold jerk JK2th in such a manner that the second threshold jerk JK2th becomes smaller as the curvature radius R becomes larger as long as the second threshold jerk JK2th is smaller than the first threshold jerk JK1th for an arbitrary the curvature radius R. It should be noted that the first threshold jerk JK1th defined by the first threshold jerk map MapJK1th(R) is represented by a dotted line in the block BL8 shown in FIG. 8, for reference.

At Step 750 shown in FIG. 8, the CPU determines whether or not the magnitude (|JK|) of the jerk JK is larger than the second threshold jerk JK2th. It should be noted that the jerk JK is calculated according to the above equation (4) similarly to Step 750 shown in FIG. 7.

When the magnitude (|JK|) of the jerk JK is larger than the second threshold jerk JK2th, the CPU makes a “Yes” determination at Step 750 shown in FIG. 8, and proceeds to Step 760 shown in FIG. 8. The CPU acquires a jerk acceleration ADjk2th which makes the magnitude (|JK|) of the jerk JK equal to or smaller than the second jerk JK2th, sets the new SPM target acceleration to the second jerk acceleration ADjk2th at Step 760, and proceeds to Step 895 to tentatively terminate the present routine.

It should be noted that the CPU calculates the second jerk acceleration ADjk2th according to equations which are obtained by replacing the first threshold jerk JK1th in the above equations (5) and (6) with the second threshold jerk JK2th.

Accordingly, a magnitude of an actual jerk (hereinafter, referred to as “an actual jerk dj”) of the vehicle VA does not become larger than a second threshold jerk JK2th which is smaller than the first threshold jerk JK1th. Hereby, the second speed management control can lower the possibility that the driver feels uneasy due to the sudden and great change in the jerk, compared with the first speed management control.

Meanwhile, when the magnitude (|JK|) of the jerk JK is equal to or smaller than the second threshold jerk JK2th, the CPU makes a “No” determination at Step 750 shown in FIG. 8, and directly proceeds to Step 895 to tentatively terminate the present routine.

As described above, the target vehicle speed Vstgt used/set by the second speed management control is lower than the target vehicle speed Vstgt used/set by the first speed management control. The second speed management control is executed when “the second situation in which at least the lane tracing control is being executed” is occurring. The first speed management control is executed when “the first situation in which the lane tracing control is not being executed” is occurring. Therefore, the movement/behavior of the vehicle VA owing to the second speed management control becomes slower/gentler than that of the vehicle VA owing to the first speed management control. Accordingly, the possibility that the driver feels uneasy while traveling in the curve section Cv under the second situation can be lowered.

### First Modification Example

A vehicle control device (hereinafter, referred to as “a first modification device”) according to a first modification example of the present control device will next be described. The first modification device differs from the present control device in that the first modification device makes the timing at which the second speed management control is started earlier than the timing at which the first speed management control should be started, and makes the timing at which the second speed management control is ended later than the timing at which the first speed management control should be ended.

The CPU of the DSECU 10 the first modification device executes the substantially same routines as the routines executed by the CPU of the DSECU 10 of the present control device. Note, however that, the CPU of the first modification device executes a routine which is obtained by modifying a part of the routine shown in FIG. 6 as follows. Furthermore, as represented by a broken line in FIG. 8, a gain map MapGa(DVs) which is used by the first modification device at Step 725 shown in FIG. 8 defines the gain Ga in such a manner that the gain Ga is smaller than the gain Ga defined by the gain map MapGa(DVs) which is used by the above described present control device for (with respect to) an arbitrary subtraction vehicle speed DVs.

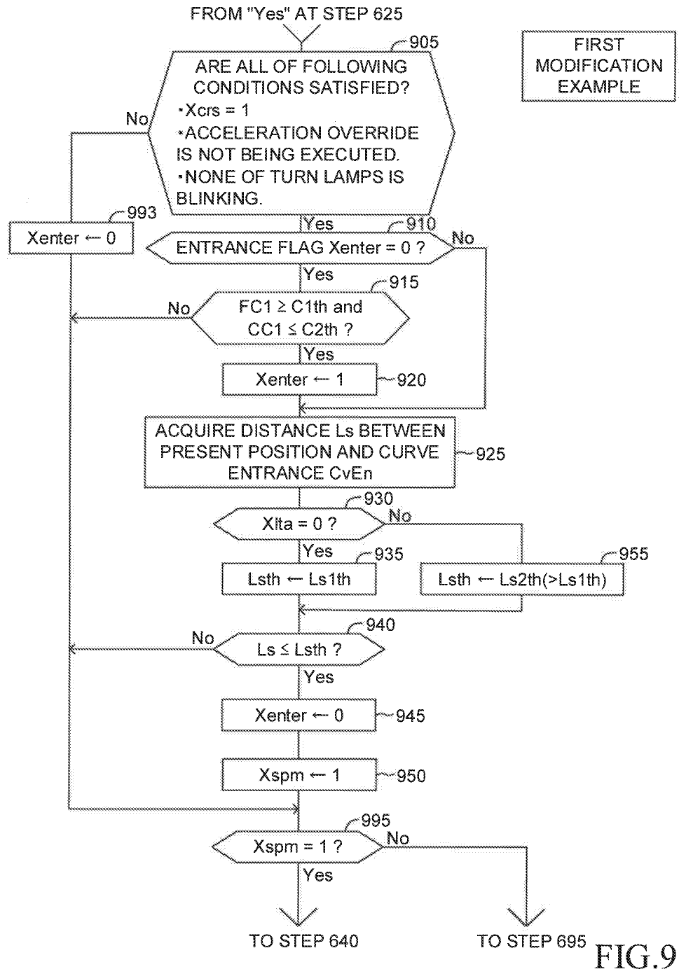

More specifically, when the CPU of the first modification device makes a “Yes” determination at Step 625 shown in FIG. 6, the CPU proceeds to Step 905 shown in FIG. 9.

At Step 905, the CPU determines whether or not all of the conditions (B2) through (B4) described as above at Step 630 shown in FIG. 6 are satisfied. When at least one of the above conditions (B2) through (B4) is not satisfied, the CPU makes a “No” determination at Step 905, and proceeds to Step 993 to set a value of an entrance flag Xenter described later to “0”. Thereafter, the CPU proceeds to Step 995 to determine whether or not the value of the speed management control flag Xspm is “1”.

When the value of the speed management control flag Xspm is not “1” (in other words, the value of the speed management control flag Xspm is “0”), the CPU makes a “No” determination at Step 995, and proceeds to Step 695 shown in FIG. 6. Therefore, in this case, the CPU proceeds to neither Step 645 nor Step 665 shown in FIG. 6, so that the CPU executes neither the first speed management control nor the second speed management control.

In contrast, when the value of the speed management control flag Xspm is “1”, the CPU makes a “Yes” determination at Step 995, and proceeds to Step 640 shown in FIG. 6. Therefore, in this case, the CPU proceeds to either one of Steps 645 and Step 665 shown in FIG. 6, so that the CPU executes either one of the first speed management control and the second speed management control.

On the other hand, when all of the above conditions (B2) through (B4) are satisfied, the CPU makes a “Yes” determination at Step 905, and proceeds to Step 910 to determine whether or not the value of the entrance flag Xenter is “0”. The CPU sets the value of the entrance flag Xenter to “1” when both of the future curvature FC and the present curvature CC satisfy the above described curvature start condition (that is, when it is determined that the future position FL has reached the curve entrance CvEn). The CPU sets the value of the entrance flag Xenter to “0” at Step 993 or “Step 945 described later”. Furthermore, the CPU sets the value of the entrance flag Xenter to “0” though the above described initialization routine.

When the value of the entrance flag Xenter is “0”, the CPU makes a “Yes” determination at Step 910, and proceeds to Step 915. At Step 915, the CPU determines whether or not the condition (B1) described for Step 630 shown in FIG. 6 is satisfied. When the above condition (B1) is not satisfied, the CPU makes a “No” determination at Step 915, and proceeds to Step 995.

In contrast, when the above condition (B1) is satisfied at the time point at which the CPU proceeds to Step 915, the CPU makes a “Yes” determination at Step 915, and proceeds to Step 920. At Step 920, the CPU sets the value of the entrance flag Xenter to “1”, and proceeds to Step 925. At Step 925, the CPU calculates a distance Ls between the present position of the vehicle VA at the present time point and the curve entrance CvEn, according to the equation (7) below. Thereafter, the CPU proceeds to Step 930.

Ls=D−Vs·tp (7)

The “D” in the above equation (7) is the distance between the above described future position FL and the front end center position CL of the vehicle VA. The “Vs” in the above equation (7) is the vehicle speed Vs. The “tp” in the above equation (7) is a time which has elapsed since a time point at which the value of the entrance flag Xenter was set to “1” (that is, a time point at which the future position FP reached a point which can be regarded as the curve entrance CvEn). It is preferable that the “D” used by this first modification device have been set to a value longer than the “D” used by the present control device.

At the time point at which the value of the entrance flag Xenter is changed into “1”, the future position FL has just reached the position which can be regarded as the curve entrance CvEn, and thus, the distance Ls between the present position of the vehicle VA and the curve entrance CvEn is equal to the predetermined distance D. The CPU acquires the distance Ls by subtracting “a distance (Vs·tp) for which the vehicle VA has traveled for a time period from the time point at which the value of the entrance flag Xenter was set/changed to “1” to the present time point” from “the predetermined distance D”

The CPU determines whether or not the value of the lane tracing control flag Xlta is “0” at Step 930. When the value of the lane tracing control flag Xlta is “0”, that is, when “the first situation in which the cruise control is being executed and the lane tracing control is not executed” is occurring, the CPU makes a “Yes” determination at Step 930, and proceeds to Step 935.

The CPU sets a threshold start distance Lsth to a first threshold start distance Ls1th at Step 935, and proceeds to Step 940. It should be noted that the first threshold start distance Ls1th has been set to a value shorter than the distance D. At Step 940, the CPU determines whether or not the distance Ls calculated at Step 925 is (or has become) equal to or shorter than the threshold start distance Lsth.

When the distance Ls is longer than the threshold start distance Lsth, the CPU makes a “No” determination at Step 940, and directly proceeds to Step 995.

When the CPU proceeds to Step 910 after the CPU has set the value of entrance flag Xenter to “1”, the CPU makes a “No” determination at Step 910, and proceeds to Step 925 directly.

When the distance Ls becomes equal to or shorter than the threshold start distance Lsth after the CPU has set the value of the entrance flag Xenter to “1”, the CPU makes a “Yes” determination at Step 940, and proceeds to Step 945. The CPU sets the value of the entrance flag Xenter to “0” at Step 945, and proceeds to Step 950. The CPU sets the value of the speed management control flag Xspm to “1” at Step 950, and proceeds to Step 995. In this case, the value of the speed management flag is “1”. Therefore, the CPU makes a “Yes” determination at Step 995, and proceeds to Step 640. Accordingly, the CPU proceeds to either one of Steps 645 and 665 shown in FIG. 6, so that the CPU executes either one of the first speed management control and the second speed management control.

In contrast, if the value of the lane tracing control flag Xlta is “1” (that is, when the second situation in which both of the cruise control and the lane tracing control are being executed) at the time point at which the CPU proceeds to Step 930, the CPU makes a “No” determination at Step 930, and proceeds to Step 955. The CPU sets the threshold start distance Lsth to a second threshold start distance Lsth which is a predetermined distance longer than the first threshold start distance Ls1th at Step 955, and proceeds to Step 940. Note, however, that the second threshold start distance Ls2th is also a distance which is equal to or shorter than the predetermined distance D.

This enables “a timing at which the distance Ls acquired at Step 925 becomes equal to or shorter than the threshold start distance Lsth” to come earlier. That is, “the timing at which the speed management control (the second speed management control) is started while the second situation is occurring” is made earlier than “the timing at which the speed management control (the first speed management control) is started while the first situation is occurring”. Accordingly, a deceleration period of time in which the vehicle speed Vs is decreased through the second speed management control before the vehicle VA enters the curve section Cv is made longer than a deceleration period of time in which the vehicle speed Vs is decreased through the first speed management control before the vehicle VA enter the curve section Cv. Therefore, the gain Ga defined by the gain map MapGa(DVs) used at Step 725 shown in FIG. 8 can be set to a smaller value, so that the possibility that the vehicle VA decelerates suddenly and greatly through the second speed management control can be made lower than through the first speed management control. Accordingly, the possibility that the vehicle can travel in the curve section Cv slowly/gently can be heightened, so that the possibility that the driver feels uneasy can be lowered.

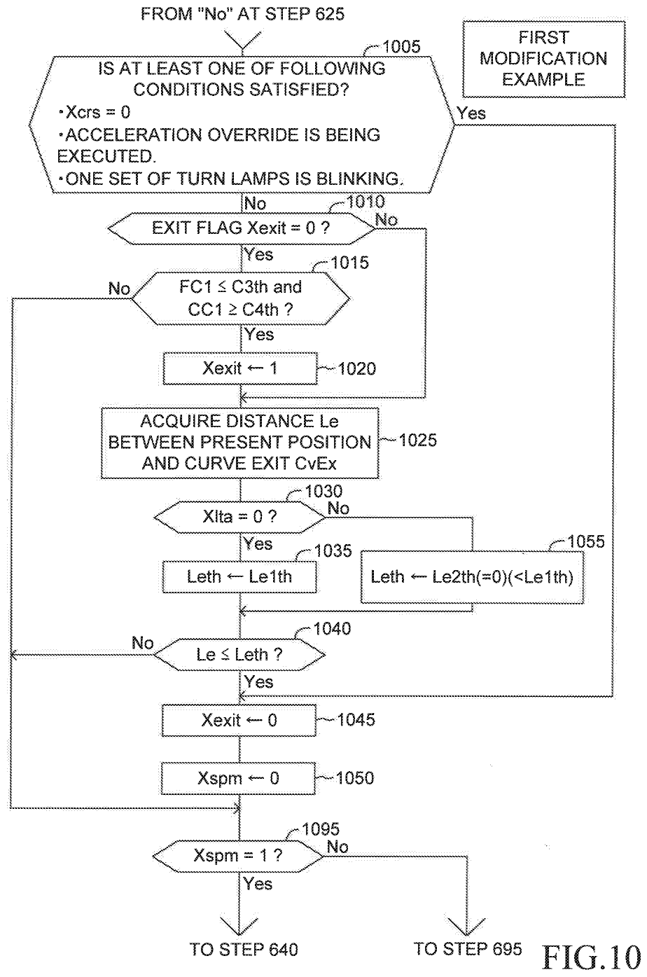

The CPU of the DSECU 10 of the first modification device proceeds to Step 1005 shown in FIG. 10 when the CPU makes a “No” determination at Step 625 shown in FIG. 6.

The CPU determines whether or not at least one of the conditions (B6) through (B8) described for Step 655 shown in FIG. 6 is satisfied at Step 1005. When none of the conditions (B6) through (B8) is satisfied, the CPU makes a “No” determination at Step 1005, and proceeds to Step 1010.

The CPU determines whether or not a value of an exit flag Xexit is “0” at Step 1010. The CPU sets the value of the exit flag Xexit to “1” when both of the future curvature FC and the present curvature CC satisfy the above described curvature end condition (that is, when it is determined that the future position FL reaches the curve exit CvEx). The CPU sets the value of the exit flag Xexit to “0” at Step 1045 described later. Furthermore, the CPU sets the value of the exit flag Xexit to “0” though the above described initialization routine.

When the value of the exit flag Xexit is “0”, the CPU makes a “Yes” determination at Step 1010, and proceeds to Step 1015. At Step 1015, the CPU determines whether or not the condition (B5) described for Step 655 shown in FIG. 6 is satisfied. When the condition (B5) is not satisfied, the CPU makes a “No” determination at Step 1015, and proceeds to Step 1095 to determine whether or not the value of the speed management control flag Xspm is “1”.

When the value of the speed management control flag Xspm is “1”, the CPU makes a “Yes” determination at Step 1095, and proceeds to Step 640 shown in FIG. 6. Accordingly, in this case, the CPU proceeds to either one of Steps 645 and 665 shown in FIG. 6, so that the CPU executes either one of the first speed management control and the second speed management control.

In contrast, when the value of the speed management control flag Xspm is not “1” (that is, when the value of the speed management control flag is “0”), the CPU makes a “No” determination at Step 1095, and proceeds to Step 695 shown in FIG. 6. Accordingly, in this case, the CPU proceeds neither Step 645 nor Step 665 shown in FIG. 6, so that the CPU executes neither the first speed management control nor the second speed management control.

On the other hand, when the above condition (B5) is satisfied at the time point at which the CPU proceeds to Step 1015, the CPU makes a “Yes” determination at Step 1015, and proceeds to Step 1020.

The CPU sets the value of the exit flag Xexit to “1” at Step 1020, and proceeds to Step 1025. At Step 1025, the CPU calculates a distance Le between the present position of the vehicle VA at the present time point and the curve exit CvEx according to the following equation (7′), and proceeds to Step 1030.

Le=D−Vs·tq (7′)

“Vs” in the equation (7′) is the vehicle speed Vs. “tq” in the equation (7′) is a time which has elapsed since the time point at which the value of the exit flag Xexit was set/changed to “1” (that is, the time point at which the future position FP reached a position which can be regarded as the curve exit CvEx).

The CPU determines whether or not the value of the lane tracing control flag Xlta is “0” at Step 1030. When the value of the lane tracing control flag Xlta is “0”, that is, when the first situation in which the cruise control is being executed and the lane tracing control is not executed is occurring, the CPU makes a “Yes” determination at Step 1030, and proceeds to Step 1035.

The CPU sets a threshold end distance Leth to a first threshold end distance Le1th at Step 1035, and proceeds to Step 1040. It should be noted that the first threshold end distance Le1th has been set to a distance shorter than the predetermined distance D. The CPU determines whether or not the distance Le calculated at Step 1025 is (or has become) equal to or shorter than the threshold end distance Leth at Step 1040.

When the distance Le is longer than the threshold end distance Leth, the CPU makes a “No” determination at Step 1040, and proceeds to Step 1095.

When the CPU proceeds to Step 1010 after the CPU has set the value of the exit flag Xexit to “1”, the CPU makes a “No” determination at Step 1010, and proceeds to Step 1025 directly.

When the distance Le becomes equal to or shorter than the threshold end distance Leth after the CPU has set the value of the exit flag Xexit to “1”, the CPU makes a “Yes” determination at Step 1040, and proceeds to Step 1045. The CPU sets the value of the exit flag Xexit to “0” at Step 1045, and proceeds to Step 1050. The CPU sets the value of the speed management control flag Xspm to “0” at Step 1050, and proceeds to Step 1095. In this case, the speed management control flag Xspm is “0”. Therefore, the CPU makes a “No” determination at Step 1095, and proceeds to Step 695. In this case, the CPU proceeds to neither Step 645 nor Step 665 shown in FIG. 6, so that the CPU executes neither the first speed management control nor the second speed management control. That is, the CPU ends the speed management control.

On the other hand, when the value of the lane tracing control flag Xlta is “1” at the time point at which the CPU proceeds to Step 1030, the CPU makes a “No” determination at Step 1030, and proceeds to Step 1055. The CPU sets the threshold end distance Leth to a second threshold end distance Le2th (e.g., “0”) which is shorter than the first threshold end distance Le1th at Step 1055, and proceeds to Step 1040.

This enables “a timing at which the speed management control (the second speed management control) is ended while the second situation is occurring” to be later than “the timing at which the speed management control (the first speed management control) is ended while the first situation is occurring”. Therefore, the second speed management control is ended when the vehicle VA reaches a position which is closer to the curve exit CvEx, as compared to the first speed manage control. Hereby, under the second situation, the CPU can lower a possibility that the speed management control is ended at a time point at which the vehicle VA is located at a position considerable far away from the curve exit CvEx so that the vehicle VA starts to be accelerated from that position. Accordingly, a possibility that the driver feels uneasy due to such a vehicle VA's acceleration can be lowered.

When at least one of the above conditions (B6) through (B8) is satisfied at the time point at which the CPU proceeds to Step 1005, the CPU makes a “Yes” determination at Step 1005, and proceeds to the processes at and after Step 1045 to end the speed management control which is being executed.

### Second Modification Example

A vehicle control device (hereinafter, referred to as “a second modification device”) according to a second modification example of the present control device will next be described. The second modification device differs from the present control device in that the second modification device enables/allows the driver to customize an allowable quickness degree in movement of the vehicle VA in the first speed management control and the second speed management control.

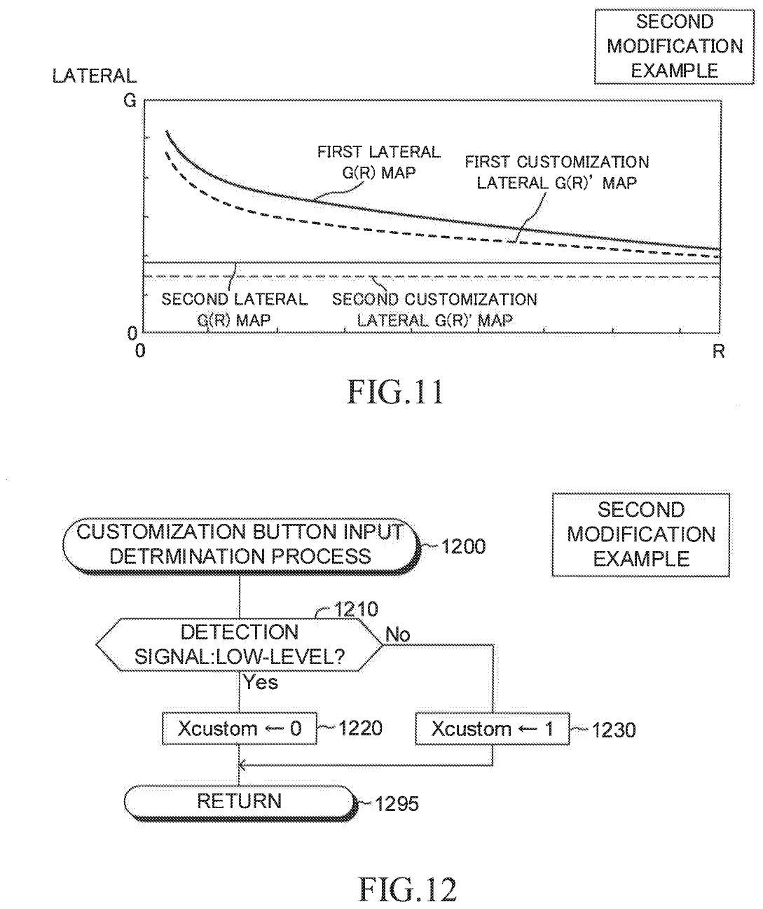

The second modification device uses a first customization lateral G (R)′ map (referring to FIG. 11) and a second customization lateral G(R)′ map (referring to FIG. 11) in addition to the first lateral G(R) map and the second lateral G(R) map. These maps have been stored in the ROM of the DSECU 10, as other maps described in the present specification.

As shown in FIG. 11, the upper limit lateral G which is acquired/determined according to the first customization lateral G(R)′ map is smaller than the upper limit lateral G which is acquired/determined according to the first lateral G(R) map. More specifically, the first customization lateral G(R)′ map defines the upper limit lateral G in such a manner that the upper limit lateral G becomes smaller as the curvature radius R of the curve section Cv becomes larger. Note, however that, the first customization lateral G(R)′ map defines the upper limit lateral G in such a manner that the upper limit lateral G is smaller than the upper limit lateral G acquired/determined according to the first lateral G(R) map for (with respect to) an arbitrary curvature radius R.

Furthermore, as shown in FIG. 11, the upper limit lateral G which is acquired/determined according to the second customization lateral G(R)′ map is smaller than the upper limit lateral G which is acquired/determined according to the second lateral G(R) map. More specifically, the second customization lateral G(R)′ map defines the upper limit lateral G in such a manner that the upper limit lateral G is a constant value regardless of the curvature radius R. Note, however that, the upper limit lateral G acquired/determined according to the second customization lateral G(R)′ map is smaller than the upper limit lateral G acquired/determined according to the second lateral G(R) map for (with respect to) an arbitrary curvature radius R, and is also smaller than the minimum of the upper limit lateral G acquired/determined according to the first lateral G(R) map.

The first customization lateral G(R)′ map and the second customization lateral G(R)′ map may be referred to as “customization Maps lateral G(R)” when they do not need to be distinguished from each other. The first lateral G(R) map and the second lateral G(R) map may be referred to as “normal Maps lateral G(R)” when they do not need to be distinguished from each other.

The second modification device further comprises the customization button 17 (referring to FIG. 1). The customization button 17 is a button which the driver operates when the driver wants to change the target vehicle speed Vstgt used through the speed management control. As described later, when the customization button 17 is operated, a look-up table used through the speed management control is changed from the normal Maps lateral G(R) to the customization Maps lateral G(R) or from the customization Maps lateral G(R) to the normal Maps lateral G(R).

The customization button 17 is configured to be able to move between an initial position and an operated position. The customization button 17 generates a low level detection signal while the customization button 17 is at the initial position. The customization button 17 generates a high level detection signal while the customization button 17 is at the operated position. The customization button 17 remains at the same position (either one of the initial position and the operated position) until the customization button 17 is operated again.

The CPU of the DSECU 10 of the second modification device executes a routine represented by a flowchart shown in FIG. 12 in addition to the routines shown in FIG. 4 through FIG. 8, every time the predetermined time elapses.

When a predetermined timing has come, the CPU starts processes from Step 1200 shown in FIG. 12, and proceeds to Step 1210 to determine whether or not the signal from the customization button 17 is the low level detection signal.

When the signal is the low level detection signal (that is, when the customization button 17 is at the initial position), the CPU makes a “Yes” determination at Step 1210, and proceeds to Step 1220 to set a customization flag Xcustom to “0”. Thereafter, the CPU proceeds to Step 1295 to tentatively terminate the present routine. It should be noted that the CPU sets the value of the customization flag Xcustom to “0” through the above described initialization routine.

In contrast, when the signal is the high level detection signal (that is, when the customization button 17 is at the operated position), the CPU makes a “No” determination at Step 1210, and proceeds to Step 1230 to set the value of the customization flag Xcustom to “1”. Thereafter, the CPU proceeds to Step 1295 to tentatively terminate the present routine.

When the CPU of the second modification device proceeds to Step 710 shown in FIG. 7, the CPU acquires the upper limit lateral G according to the first lateral G(R) map if the value of the customization flag Xcustom is “0”. In contrast, the CPU acquires the upper limit lateral G according to the first customization lateral G(R)′ map at Step 710 if the value of the customization flag Xcustom is “1”.

When the CPU of the second modification device proceeds to Step 805 shown in FIG. 8, the CPU acquires the upper limit lateral G according to the second lateral G(R) map if the customization flag Xcustom is “0”. In contrast, the CPU acquires the upper limit lateral G according to the second customization lateral G(R)′ map at Step 805 if the value of the customization flag Xcustom is “1”.

According to the second modification device configured as above, the driver just operates the customization button 17 when the driver prefers the speed management control which makes the lateral G smaller than the normal. That is, the second modification device can provide the speed management control which suits the driver's preference.

Moreover, the second modification device may use a first customization threshold acceleration map MapAD1th(R)′ and a second customization threshold acceleration map MapAD2th(R)′ in addition to the first threshold acceleration map MapAD1th(R) and the second threshold acceleration map MapAD2th(R).

The first threshold acceleration AD1th acquired/determined according to the first customization threshold acceleration map MapAD1th(R)′ is smaller than the first threshold acceleration AD1th acquired/determined according to the first threshold acceleration map MapAD1th(R). More specifically, the first customization threshold acceleration map MapAD1th(R)′ defines the first threshold acceleration AD1th in such a manner that the first threshold acceleration AD1th becomes smaller as the curvature radius R of the curve section Cv becomes larger.

The second threshold acceleration AD2th acquired/determined according to the second customization threshold acceleration map MapAD2th(R)′ is smaller than the second threshold acceleration AD2th acquired/determined according to the second threshold acceleration map MapAD2th(R). More specifically, the second customization threshold acceleration map MapAD2th(R)′ defines the second threshold acceleration AD2th in such a manner that the second threshold acceleration AD2th is a constant value regardless of the curvature radius R of the curve section Cv. Note, however that, the second customization threshold acceleration map MapAD2th(R)′ defines the second threshold acceleration AD2th in such a manner that the second threshold acceleration AD2th is smaller than minimum of the first threshold acceleration AD1th which is acquired/determined according to the first customization threshold acceleration map MapAD1th(R)′.

When the CPU proceeds to Step 735 shown in FIG. 7, the CPU acquires the first threshold acceleration AD1th according to the first threshold acceleration map MapAD1th(R) if the value of the customization flag Xcustom is “0”. In contrast, if the value of the customization flag Xcustom is “1”, the CPU acquires the first threshold acceleration AD1th according to the first customization threshold acceleration map MapAD1th(R)′ at Step 735

When the CPU proceeds to Step 810 shown in FIG. 8, the CPU acquires the second threshold acceleration AD2th according to the second threshold acceleration map MapAD2th(R) if the value of the customization flag Xcustom is “0”. In contrast, if the value of the customization flag Xcustom is “1”, the CPU acquires the second threshold acceleration AD2th according to the second customization threshold acceleration map MapAD2th(R)′ at Step 810.

Furthermore, the second modification device may use a first customization threshold jerk map MapJK1th(R)′ and a second customization threshold jerk map MapJK2th(R)′ in addition to the first threshold jerk map MapJK1th(R) and the second threshold jerk map MapJK2th(R).

The first threshold jerk JK1th acquired/determined according to the first customization threshold jerk map MapJK1th(R)′ is smaller than the first threshold jerk JK1th acquired/determined according to the first threshold jerk map MapJK1th(R) for (with respect to) an arbitrary curvature radius R. More specifically, the first customization threshold acceleration map MapAD1th(R)′ defines the first threshold jerk JK1th in such a manner that the first threshold jerk JK1th becomes smaller as the curvature radius R of the curve section Cv becomes larger.

The second threshold jerk JK2th acquired/determined according to the second customization threshold jerk map MapJK2th(R)′ is smaller than the second threshold jerk JK2th acquired/determined according to the second threshold jerk map MapJK2th(R). More specifically, the second customization threshold jerk map MapJK2th(R)′ defines the second threshold jerk JK2th in such a manner that the second threshold jerk JK2th is a constant value regardless of the curvature radius R of the curve section Cv. Note, however that, the second customization threshold jerk map MapJK2th(R)′ defines the second threshold jerk JK2th in such a manner that the second threshold jerk JK2th is smaller than the minimum of the first threshold jerk JK1th acquired/determined according to the first customization threshold jerk map MapJK1th(R)′.

When the CPU proceeds to Step 745 shown in FIG. 7, the CPU acquires the first threshold jerk JK1th according to the first threshold jerk map MapJK1th(R) if the value of the customization flag Xcustom is “0”. In contrast, if the value of the customization flag Xcustom is “1”, the CPU acquires the first threshold jerk JK1th according to the first customization threshold jerk map MapJK1th(R)′ at Step 745.

When the CPU proceeds to Step 815 shown in FIG. 8, the CPU acquires the second threshold jerk JK2th according to the second threshold jerk map MapJK2th(R) if the value of the customization flag Xcustom is “0”. In contrast, if the value of the customization flag Xcustom is “1”, the CPU acquires the second threshold jerk JK2th according to the second customization threshold jerk map MapJK2th(R)′ at Step 815.

According to the second modification device configured as described above, the driver just operates the customization button 17 when the driver prefers the speed management control which enables the vehicle VA to travel in the curve section Cv more gently/slowly. That is, the second modification device can provide the speed management control which suits the driver's preference.

It should be noted that the first lateral G(R) map may be the same as the first customization lateral G(R)′ map. That is, the second modification device may decreases at least the upper limit lateral G determined/acquired under the second situation, so as to decrease the second target vehicle speed determined based on the upper limit lateral G, when the driver performs a predetermined operation on/to the customization button 17, as compared with when the driver does not perform the predetermined operation. Similarly, the first threshold acceleration map MapAD1th(R) may be the same as the first customization threshold acceleration map MapAD1th(R)′. Furthermore, the first threshold jerk map MapJK1th(R) may be the same as the first customization threshold jerk map MapJK1th(R)′.

### Third Modification Example

A vehicle control device (hereinafter, referred to as “a third modification device”) according to a third modification example will next be described.

The third modification differs from the present control device in the following point.

When information on surroundings of the vehicle VA in the vehicle width direction satisfies a predetermined condition (a specific condition), the third modification device modifies the upper limit lateral G or the like in such a manner that the upper limit lateral G or the like become smaller than those used when the information on the surroundings does not satisfy the predetermined condition. The predetermined condition is satisfied when the information on the surroundings indicates that the surroundings are as such that cause the driver to easily feel uneasy.

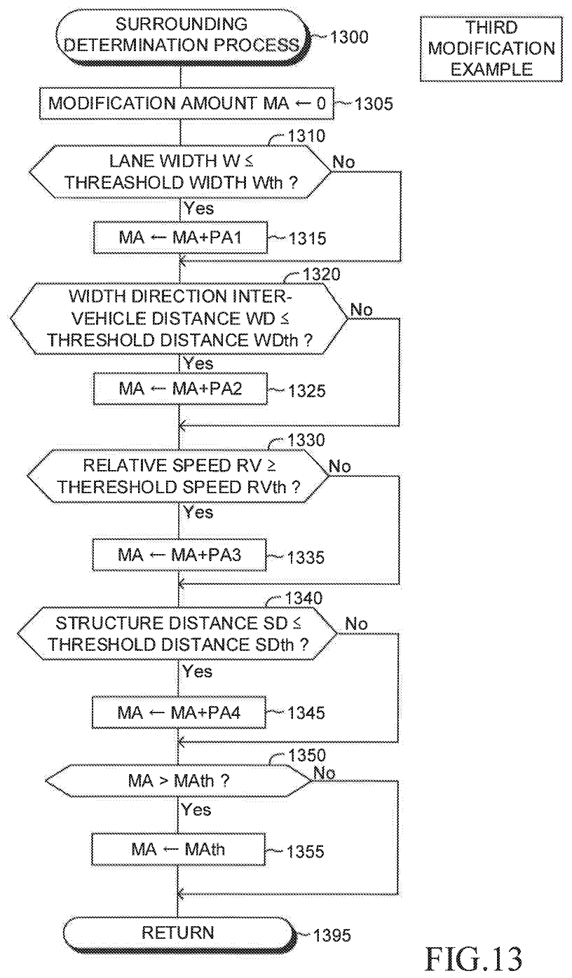

The CPU of the DSECU 10 of the third modification device executes a routine represented by a flowchart shown in FIG. 13 in addition to the routines shown in FIG. 4 through FIG. 8, every time the predetermined time elapses. When a predetermined timing has come, the CPU starts processes from Step 1300 shown in FIG. 13, and proceeds to Step 1305 to set a modification amount MA to “0” to initialize the modification amount MA. Thereafter, the CPU proceeds to Step 1310.

At Step 1310, the CPU determines whether or not a lane width W (referring to FIG. 3) is equal to or shorter than a threshold width Wth. In other words, the CPU determines whether or not a first condition is satisfied. The lane width W is a distance between the right white line RL and the left white line LL which are recognized based on the image data obtained by the camera device 12.

When the lane width W is equal to or shorter than the threshold width Wth, the CPU makes a “Yes” determination at Step 1310, and proceeds to Step 1315 to add a first predetermined amount PA1 to the modification amount MA. Thereafter, the CPU proceeds to Step 1320. In contrast, when the lane width W is larger than the threshold width Wth, the CPU makes a “No” determination at Step 1310, and directly proceeds to Step 1320.

At Step 1320, the CPU acquires a width direction inter-vehicle distance WD based on the image data obtained by the camera device 12. The width direction inter-vehicle distance WD is a distance in the vehicle width direction between “the other vehicle which is traveling in a lane adjacent to the traveling lane in which the vehicle VA is running” and “the vehicle VA”. Thereafter, the CPU determines whether or not the width direction inter-vehicle distance WD is equal to or shorter than a first threshold distance WDth. In other words, the CPU determines whether or not the second condition is satisfied.

When the width direction inter-vehicle distance WD is equal to or shorter than the threshold distance WDth, the CPU makes a “Yes” determination at Step 1320, and proceeds to Step 1325 to add a second predetermined amount PA2 to the modification amount MA. Thereafter, the CPU proceeds to Step 1330. In contrast, when the width direction inter-vehicle distance WD is longer than a first threshold distance WD1th, the CPU makes a “No” determination at Step 1320, and directly proceeds to Step 1330.

At Step 1330, the CPU acquires a relative speed RV in the vehicle width direction between the vehicle VA and the other vehicle based on records of the position of the other vehicle. The relative speed RV is a positive value when the other vehicle and the vehicle VA are approaching in the vehicle width direction. Furthermore, the CPU determines whether or not the relative speed RV is equal to or higher than a positive threshold speed RVth. That is, the CPU determines whether or not the other vehicle and the vehicle VA are approaching at the relative speed RV which is equal to or higher than the threshold speed RVth. In other words, the CPU determines whether or not a third condition is satisfied.

When the relative speed RV is equal to or higher than the threshold speed RVth, the CPU makes a “Yes” determination, and proceeds to Step 1335 to add a third predetermined amount PA3 to the modification amount MA. Thereafter, the CPU proceeds to Step 1340. In contrast, when the relative speed RV is lower than the threshold speed RVth, the CPU makes a “No” determination at Step 1330, and directly proceeds to Step 1340.

At Step 1340, the CPU determines whether or not a structure distance SD is equal to or shorter than a second threshold distance SDth. In other words, the CPU determines whether or not a fourth condition is satisfied. The structure distance is a distance between a continuous structure (e.g., a guardrail, and a wall) and the vehicle VA. It should be noted that the continuous structure is an object which continuously extends to have a predetermined distance or longer along the lane. The process for recognizing the continuous structure is a well-known process. For example, such a process is disclosed in Japanese Patent Application Laid-open No. 2018-149901, and Japanese Patent Application Laid-open No. 2018-151816.

When the structure distance SD is equal to or shorter than the second threshold distance SDth, the CPU makes a “Yes” determination at Step 1340, and proceeds to Step 1345 to add a fourth amount PA4 to the modification amount MA. Thereafter, the CPU proceeds to Step 1350. In contrast, when the structure distance SD is longer than the second threshold distance SDth, the CPU makes a “No” determination at Step 1340, and directly proceeds to Step 1350.

At Step 1350, the CPU determines whether or not the modification amount MA is larger than a threshold modification amount MAth. When the modification amount MA is larger than the threshold modification amount MAth, the CPU makes a “Yes” determination at Step 1350, and proceeds to Step 1355 to set the modification amount MA to the threshold modification amount MAth. Thereafter, the CPU proceeds to Step 1395 to tentatively terminate the present routine. On the other hand, when the modification amount MA is equal to or smaller than the threshold modification amount MAth, the CPU makes a “No” determination at Step 1350, and directly proceeds to Step 1395 to tentatively terminate the present routine.

When the CPU proceeds to Step 710 shown in FIG. 7 or Step 805 shown in FIG. 8, the CPU employs, as the upper limit lateral G, a value which is acquired by subtracting a lateral G corresponding to the modification amount MA (a lateral G which becomes larger as the modification amount MA becomes larger) from the upper limit lateral G acquired at Step 710 or Step 805.

Furthermore, when the CPU proceeds to Step 735 shown in FIG. 7, the CPU employs, as the first threshold acceleration AD1th, a value which is acquired by subtracting an acceleration corresponding to the modification amount MA (a first modification acceleration which becomes larger as the modification amount MA becomes larger) from the first threshold acceleration AD1th acquired at Step 735. Similarly, when the CPU proceeds to Step 810 shown in FIG. 8, the CPU employs, as the second threshold acceleration AD2th, a value which is acquired by subtracting an acceleration corresponding to the modification amount MA (a second modification acceleration which becomes larger as the modification amount MA becomes larger) from the second threshold acceleration AD2th acquired at Step 810.

Furthermore, when the CPU proceeds to Step 745 shown in FIG. 7, the CPU employs, as the first threshold jerk JK1th, a value which is acquired by subtracting a jerk corresponding to the modification amount MA (a first modification jerk which becomes larger as the modification amount MA becomes larger) from the first threshold jerk JK1th acquired at Step 745. Similarly, when the CPU proceeds to Step 815 shown in FIG. 8, the CPU employs, as the second threshold jerk JK2th, a value which is acquired by subtracting a jerk corresponding to the modification amount MA (a second modification jerk which becomes larger as the modification amount MA becomes larger) from the second threshold jerk JK2th acquired at Step 815.

In the case where the CPU executes the routines shown in FIG. 9 and FIG. 10 like the first modification example, the CPU employs, as the threshold start distance Lsth, a value which is acquired by adding a distance corresponding to the modification amount MA (a first modification amount which becomes longer as the modification amount MA becomes larger) to the threshold start distance Lsth, when the CPU proceeds to Step 940 shown in FIG. 9. Furthermore, the CPU employs, as the threshold end distance Leth, a value which is acquired by subtracting a distance corresponding to the modification amount MA (a second modification amount which becomes longer as the modification amount MA becomes larger) from the threshold end distance Leth, when the CPU proceeds to Step 1040 shown in FIG. 10.

As understood from the above, when “a condition consisting of a combination of one or more of the first condition through the fourth condition” is satisfied, it is determined that the information on the surroundings satisfies the above described predetermined condition (the specific condition) which is to be satisfied when the information on the surroundings indicates that the surroundings are as such that cause the driver to easily feel uneasy.

### Fourth Modification Example

A vehicle control device (hereinafter, referred to as “a fourth modification device”) according to a fourth modification example calculates the SPM target acceleration GSPMtgt using a navigation system 18.

The navigation system 18 has stored map data (road data or navigation information) including a location of the curve section Cv on the earth's surface, a curvature of the curve section Cv, and the like.

A GPS receiver 19 receives GPS signals from GPS satellites, every time a predetermined elapses. The GPS receiver 19 specifies/identifies the present position of the vehicle VA on the earth's surface based on the received GPS signals. Subsequently, the CPU transmits a position signal enabling the DSECU 10 to specify/identify the present position of the vehicle VA to the DSECU 10.

The CPU of the DSECU 10 of the fourth modification device executes the substantially same routines as the routines executed by the CPU of the DSECU 10 of the present control device. Note, however that, when executing the routine shown in FIG. 6, the CPU of the DSECU 10 of the fourth modification device executes a fourth modification example routine which is the same routine as the routine shown in FIG. 6 except that Step 610 shown in FIG. 6 is omitted and Steps 615 and 620 shown in FIG. 6 are changed as follows.

The CPU starts processes of the fourth modification example routine from Step 600, and executes Step 605. Thereafter, the CPU proceeds to Step 615 without proceeding to Step 610. At Step 615, the CPU obtains the curvature of the traveling road at the future position the predetermined distance away from the present position of the vehicle VA in the travel direction of the vehicle VA as the future curvature FC, through referring to the map data (the navigation information) of the navigation system 18.

Subsequently, the CPU proceeds to Step 620 to obtain the curvature of the traveling road at the present position of the vehicle VA as the present curvature CC, through referring to the map data (the navigation information). Thereafter, the CPU proceeds to Step 625. The processes of and after Step 625 are the same as the processes of the routine executed by the above described present control device. Therefore, description thereof is omitted.

The present disclosure is not limited to the above described embodiments including modifications, and can employ various other modifications within a scope of the present disclosure.

For example, each of the first lateral G(R) map and the second lateral G(R) map may defines “a target vehicle speed specified value for the curvature R of the curve section Cv” in place of the upper limit lateral G. The target vehicle speed specified value is a value which enables the CPU to specify/determine the target vehicle speed Vstgt. For example, the target vehicle speed specified value may be the target vehicle speed Vstgt itself. In this case, the target vehicle speed Vstgt specified/determined by the target vehicle speed specified value which is defined by the second lateral G(R) map has been set to a value smaller than the target vehicle speed Vstgt specified/determined by the target vehicle speed specified value which is defined by the first lateral G(R) map.

Furthermore, the DSECU 10 may calculate the curvature C of the curve section Cv for calculating the SPM target acceleration GSPMtgt, using a yaw rate method described later after the vehicle has entered the curve section Cv. The yaw rate method is a well-known method. For example, such a method is disclosed on Japanese Patent Application Laid-open No. 2009-51487, and WO 2010/073300. According to the yaw rate method, the DSECU 10 acquires the curvature radius R by applying the yaw rate Yr and the vehicle speed Vs to the following equation (8), and then acquires the reciprocal of the curvature radius R as the present curvature CC. The DSECU 10 acquires the SPM target acceleration GSPMtgt based on the present curvature CC.

R=Vs/Yr (8)

A stereo camera device which can measure a distance to the obstacle accurately may be adopted/employed as the camera device 12. In this case, the above described vehicle control device does not necessarily comprise the millimeter wave radar device 13.

The millimeter wave radar device 13 may be any device/sensor which transmits/emits a wireless medium to detect the obstacle by receiving a reflected wireless medium of the obstacle.

In the above embodiment, the lane tracing control is executed only when the cruise control is being executed. However, the lane tracing control may be executed separately/independently from the cruise control (that is, regardless of whether or not the cruise control is being executed).

The speed management control is executed only when the cruise control is being executed. However, the speed management control may be executed separately/independently from the cruise control (that is, regardless of whether or not the cruise control is being executed).

What is claimed is:

1. A vehicle control device comprising:
sensing devices configured to acquire information on at least a traveling state of a vehicle;
actuators configured to control the traveling state of the vehicle; and
a control unit configured to:
execute a speed management control to let the vehicle travel using the information and the actuators in such a manner that a vehicle speed of when the vehicle is traveling in a curve section does not exceed a target vehicle speed serving as an upper limit speed; and
execute a lane tracing control to let the vehicle travel using the information and the actuators in such a manner that the vehicle travels along a lane in which the vehicle is traveling, in a time period from a start time point at which a predetermined start condition becomes satisfied to an end time point at which a predetermined end condition becomes satisfied,
wherein the control unit is configured to:
set the target vehicle speed to a first target vehicle speed in a first situation in which the lane tracing control is not being executed; and
set the target vehicle speed to a second target vehicle speed which is lower than the first target vehicle speed in a second situation in which the lane tracing control is being executed.

2. The vehicle control device according to claim 1,
wherein the control unit is configured to:
determine, as a first upper limit lateral acceleration, an allowable upper limit value of an acceleration acting on the vehicle in a vehicle width direction of the vehicle in a period when the vehicle travels in the curve section in the first situation, and determine the first target vehicle speed based on the first upper limit lateral acceleration; and
determine, as a second upper limit lateral acceleration, an allowable upper limit value of an acceleration acting on the vehicle in the vehicle width direction of the vehicle in a period when the vehicle travels in the curve section in the second situation so as to make the second upper limit lateral acceleration be smaller than first upper limit lateral acceleration, and determine the second target vehicle speed based on the second upper limit lateral acceleration.

3. The vehicle control device according to claim 1,
wherein the control unit is configured to:
decrease the vehicle speed to the first target vehicle speed in such a manner that a magnitude of an acceleration of the vehicle does not exceed a first threshold acceleration, in the first situation; and
decrease the vehicle speed to the second target vehicle speed in such a manner that the magnitude of the acceleration of the vehicle does not exceed a second threshold acceleration which is set to be smaller than the first threshold acceleration, in the second situation.

4. The vehicle control device according to claim 1,
wherein the control unit is configured to:
decrease the vehicle speed to the first target vehicle speed in such a manner that a magnitude of a derivation value of an acceleration of the vehicle does not exceed a first threshold jerk, in the first situation; and
decrease the vehicle speed to the second target vehicle speed in such a manner that the magnitude of the derivation value of the acceleration of the vehicle does not exceed a second threshold jerk which is set to be smaller than the first threshold jerk, in the second situation.

5. The vehicle control device according to claim 1,
wherein the control unit is configured to:
start decreasing the vehicle speed to the first target vehicle speed at a first start timing in the first situation; and
start decreasing the vehicle speed to the second target vehicle speed at a second start timing in the second situation, the second timing being determined to come earlier than the first start timing.

6. The vehicle control device according to claim 1,
wherein the control unit is configured to:
determine whether or not a driver of the vehicle has performed a predetermined operation; and
set the second target vehicle speed to a value smaller than a value to which the second target vehicle speed is set when the driver has not performed the predetermined operation, when the driver has performed the predetermined operation.

7. The vehicle control device according to claim 1,
wherein,
the sensing devices include at least a device configured to acquire information on surroundings of the vehicle; and
the control unit is configured to set the second target vehicle speed to a value smaller than a value to which the second target vehicle speed is set when the information on the surroundings does not satisfy a predetermined condition, when the information on the surroundings satisfies the predetermined condition.

8. The vehicle control device according to claim 7,
wherein the control unit is configured to determine that the information on the surroundings satisfies the predetermined condition when at least one of a first condition, a second condition, a third condition, and a fourth condition is satisfied,
wherein,
the first condition is a condition satisfied when a width of the lane is equal to or smaller than a threshold width,
the second condition is satisfied when a distance between the vehicle and an other vehicle in a vehicle width direction of the vehicle is equal to or shorter than a first threshold distance,
the third condition is satisfied when the other vehicle approaches the vehicle in the vehicle width direction at a speed which is equal to or higher than a threshold speed, and
the fourth condition is satisfied when a distance between the vehicle and a structure around the vehicle is equal to or shorter than a second threshold distance.
